(19) United States
(12) Patent Application Publication
(10) Pub. No.: US 2012/0329587 A1
(43) Pub. Date: Dec. 27, 2012

(54) Sports ball

(76) Inventor: Tsung Ming OU, Kaohsiung (TW)

(21) Appl. No.: 13/573,205

(22) Filed: Aug. 29, 2012

Related U.S. Application Data
(63) Continuation-in-part of application No. 12/317,083, filed on Dec. 18, 2008.
Application No. 12/317,083 is a continuation-in-part of application No. 11/637,378, filed on Dec. 11, 2006, now Pat. No. 7,837,581.

(51) Int. Cl. A63B 41/10; B32B 38/10; B32B 37/02; A63B 41/00; A63B 45/00

(52) U.S. Cl. 473/605; 473/604; 156/293; 156/256; 156/60

(57) ABSTRACT

A sports ball includes an inflatable bladder, a ball pocket and a ball carcass. The ball pocket has an interior cavity receiving the inflatable bladder therein, wherein the ball pocket has a plurality of panel guidelines protruded from an outer surface of the ball pocket to define a predetermined number of guiding contours between at least two adjacent panel guidelines. The ball carcass includes a plurality of carcass panels, wherein each of the carcass panels has a peripheral edge and a flat bottom surface defined within the peripheral edge, wherein the bottom surface of each of the carcass panels is entirely affixed to the ball pocket at a position that the peripheral edge of each of the carcass panels is fittingly aligned with the corresponding panel guidelines so as to fittedly affix on the corresponding guiding contours to form a sportsball in a stitch-less manner.

### CROSS REFERENCE OF RELATED APPLICATION

This is a Continuation-In-Part (CIP) of a non-provisional application having an application Ser. No. 12/317,083, and a filing date of Dec. 18, 2008, which is a Continuation-In-Part of a non-provisional application having an application Ser. No. 11/637,378 and a filing date of Dec. 11, 2006.

### BACKGROUND OF THE PRESENT INVENTION

1. Field of Invention

The present invention relates to a ball, and more particularly to a sports ball comprising a plurality of carcass panels attached on a ball cushion to form a roundness carcass of the sports ball in a stitch-less manner.

2. Description of Related Arts

A conventional sports ball, such as a conventional soccer ball, usually comprises a ball bladder, an inner lining, and a ball carcass. The ball carcass comprises a plurality of carcass panels attached on the ball bladder, wherein each of the carcass panels is usually stitched to adjacent carcass panels for forming a substantially round sports ball. Traditionally, much has been done in the development of the ball bladder and intermediate construction between the ball bladder and the ball carcass. For example, U.S. Pat. No. of 6,663,520 to Li Chin Ou Chen discloses a ball pocket bladder for a stitching ball. It aims to enhance the immediate construction between the ball bladder and the outer carcass with a view to enhance the overall structural integrity of the entire stitching ball.

However, there are also several other disadvantages for the stitching structure of soccer balls. For example, the carcass panels, being stitched onto the ball bladder, involve expensive and time-consuming manufacturing procedures, yet the resulting sports ball may not have the optimal roundness. One particularly-pressing problem for conventional stitched sports ball is that the carcass panels cannot have too sharp a shape for it is difficult for sharp concerns to be adequately stitched with adjacent carcass panels.

As a result, sports balls having a stitch-less structure have been developed to overcome the many conventional deep-seated problems present in stitched sports ball. For example, U.S. Pat. No. of 6,685,585 to Hiroshima et al. discloses a ball for a ball game comprising an elastic bladder, a reinforced layer, and a plurality of leather panels. More specifically, each of the leather panels is bonded onto the reinforced layer, wherein a peripheral edge portion of each leather panels is folded toward an inside. A thickness adjusting member is disposed in a void defined by the folded peripheral portions and bonded onto a back of each leather panel. Although this sports ball does not involve stitching on the leather panels, thereby substantially overcoming the disadvantages associated with stitching, it has several other disadvantages.

First, the Hiroshima's patent specifically discloses a bonding technique thereby each of the leather panels is inwardly folded at the corresponding peripheral portion to bond with the thickness adjusting member. Thus, the Hiroshima's patent discloses a state of art where each the leather panels has two portions, a main portion which is above the thickness adjusting member, and a peripheral portion which is bonded at side portions of the corresponding thickness adjusting member. Now, the problem with this construction is that while the main portion of each of the leather panels is elastically supported by the thickness adjusting member, the corresponding peripheral portion does not. As a result, the sports ball suffers from non-uniform cushion effect because of the bonding technique of the leather panels. When a user of that invention kicks on the main portion of the leather panel, he will enjoy substantial cushioning effect from the thickness adjusting member. However, when the user kicks on the peripheral portion of the leather panel, he will cease to enjoy the same amount of cushioning effect as if he kicks on the main portion.

Second, it is reasonably clear that in order to manufacture the ball stated in the Hiroshima's patent, one must take substantial amount of time for precise and effective attachment between the thickness adjusting member and the leather panels. In other words, the ball disclosed in the Hiroshima's patent requires expensive manufacturing cost. Moreover, since the manufacturing procedures are time-consuming, when the balls are needed in large quantity, such as when the inventors or their assignees or the licensors need to meet substantial market demand, there is little chance that they could produce the balls in large quantity in a relatively short period of time. This is extremely important because major soccer events, such as World Cup, are only held once in a few year.

### SUMMARY OF THE PRESENT INVENTION

The invention is advantageous in that it provides a sports ball comprising a plurality of carcass panels attached on a ball cushion to form a roundness carcass of the sports ball in a stitch-less manner.

Another advantage of the invention is to provide a sports ball comprising a plurality of carcass panels each of which has a slanted edge portion, wherein a thickness of the edge portion of each of the carcass panels is gradually reducing towards a peripheral edge thereof. In other words, the present invention does not utilize folding of the carcass panels for attaching on the inflatable bladder, thereby substantially overcoming the above-mentioned shortcomings of the conventional sports ball.

Another advantage of the invention is to provide a sports ball comprising a ball cushion which provides a uniform cushioning effect to the entire sports ball for enhancing a performance thereof. A remarkable feature of the present invention is that the carcass panels can be cut into a wide variety of shapes without affecting the cushioning effect of the sports ball, or the attachment effectiveness between the ball carcass and the ball cushion.

Another Advantage of the Invention is to Provide a Sports Ball

Another advantage of the present invention is that it provides a method of manufacturing the above-mentioned sports ball, wherein the manufacturing method is simple, cost-effective, and efficient. In other words, the present invention provides an optimal method of producing a large quantity of sports ball in a relatively short period of time.

Additional advantages and features of the invention will become apparent from the description which follows, and may be realized by means of the instrumentalities and combinations particular point out in the appended claims.

According to the present invention, the foregoing and other objects and advantages are attained by providing a sports ball, comprising:

an inflatable bladder having a valve stem extended therefrom;

a ball pocket, which is constructed to have a true roundness shape, having an interior cavity receiving the inflatable bladder therein, wherein when the inflatable bladder is inflated, the ball pocket retains a true roundness shape of the inflatable bladder, wherein the ball pocket has a plurality of panel guidelines protruded from an outer surface of the ball pocket to define a predetermined number of guiding contours between at least two adjacent panel guidelines; and

a ball carcass which comprises a plurality of carcass panels, wherein each of the carcass panels having a peripheral edge and a flat bottom surface defined within the peripheral edge, wherein the bottom surface of each of the carcass panels is entirely affixed to the ball pocket at a position that the peripheral edge of each of the carcass panels is fittingly aligned with the corresponding panel guidelines so as to fittedly affix on the corresponding guiding contours to form a roundness carcass of the sportsball in a stitch-less manner.

According to another aspect of the present invention, the present invention also provides a sportsball, comprising:

an inflatable bladder having a valve stem extended therefrom;

an exterior web layer which is integrally attached on an outer surface of the inflatable bladder, and comprises at least an elongated strengthened thread evenly wound around the outer surface of the inflatable bladder such that the web layer embraces the inflatable bladder for resisting stress and impact force applied to the inflatable bladder;

a ball cushion, which is constructed to have a true roundness shape, receiving the ball exterior web layer and the inflatable bladder therein, wherein the ball cushion further has a plurality of panel guidelines protruded from an outer surface of the ball cushion to define a predetermined number of guiding contours between at least two adjacent panel guidelines; and

a ball carcass which comprises a plurality of carcass panels, wherein each of the carcass panels having a peripheral edge and a flat bottom surface defined within the peripheral edge, wherein the bottom surface of each of the carcass panels is entirely affixed to the ball cushion at a position that the peripheral edge of each of the carcass panels is fittingly aligned with the corresponding panel guidelines so as to fittedly affixed on the corresponding guiding contours to form a roundness carcass of the sportsball in a stitch-less manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a sports ball according to a first preferred embodiment of the present invention.

FIG. 2 is a side view of the sports ball according to the above first preferred embodiment of the present invention.

FIGS. 3A to 3V are schematic diagrams of a method of manufacturing a sports ball according to the above first preferred embodiment of the present invention.

FIGS. 4A to 4V are schematic diagrams of an alternative mode of the method of manufacturing the sports ball according to the above first preferred embodiment of the present invention.

FIGS. 5S to 5V are schematic diagrams illustrating an alternative mode of the ball carcass according to the above first preferred embodiment of the present invention

FIG. 6A to FIG. 6D are schematic diagrams of a method of manufacturing a sports ball according to a second preferred embodiment of the present invention.

FIG. 7 is a perspective view of a sports ball according to a second preferred embodiment of the present invention.

FIG. 8 is a perspective view of the inflatable bladder body of the sports ball according to the above second preferred embodiment of the present invention.

FIG. 9 is a sectional side view of the sports ball according to the above second preferred embodiment of the present invention.

FIG. 10 is a perspective view of an alternative mode of the sports ball according to the above second preferred embodiment of the present invention.

FIG. 11 is a perspective view of the alternative mode of the inflatable bladder body of the sports ball according to the above second preferred embodiment of the present invention.

FIG. 12 is a sectional side view of the alternative mode of the sports ball according to the above second preferred embodiment of the present invention.

FIG. 13 is a perspective view of a sports ball according to a third preferred embodiment of the present invention.

FIG. 14 is a side view of the sports ball according to the above third preferred embodiment of the present invention.

FIG. 15A to FIG. 151 are schematic diagrams of a method of manufacturing a sports ball according to the above third preferred embodiment of the present invention.

FIG. 16 is a perspective view of a sports ball according to a fourth preferred embodiment of the present invention.

FIG. 17 is a side view of the sports ball according to the above fourth preferred embodiment of the present invention.

FIG. 18A to FIG. 18M are schematic diagrams of a method of manufacturing a sports ball according to the above fourth preferred embodiment of the present invention.

### DETAILED DESCRIPTION OF THE PREFERRED EMBODIMENT

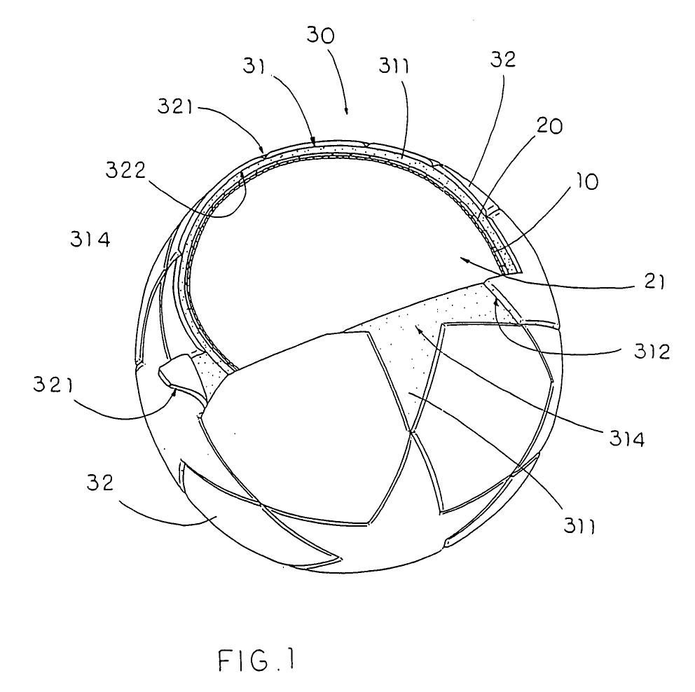

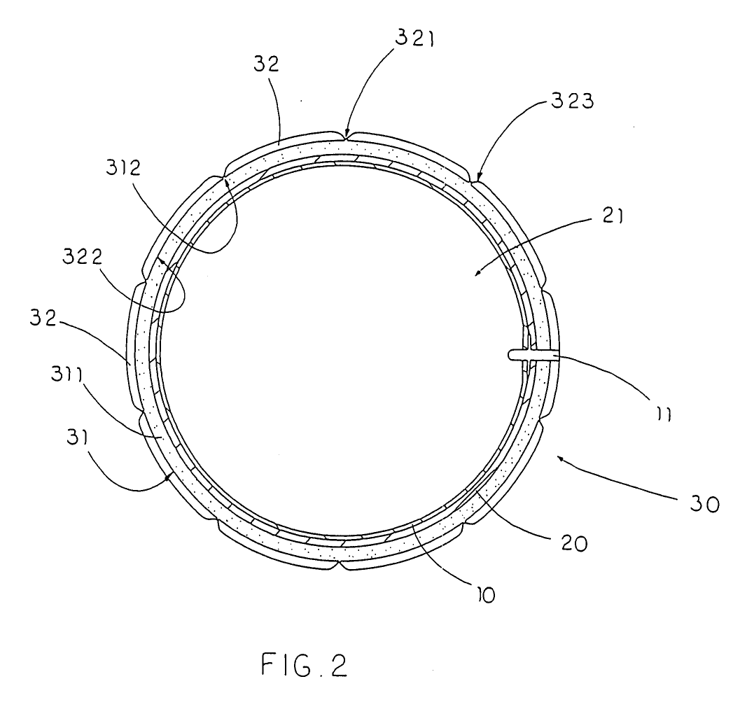

Referring to FIG. 1 to FIG. 2 of the drawings, a sports ball, such as a soccer ball, according to a first preferred embodiment of the present invention is illustrated, in which the sports ball comprises an inflatable bladder 10 having a valve stem 11 extended therefrom, a ball pocket 20, and a ball carcass 30.

The ball pocket 20, which is constructed to have a true roundness shape, having an interior cavity 21 receiving the inflatable bladder 10 therein, in which when the inflatable bladder 10 is inflated, the ball pocket 20 retains a true roundness shape of the inflatable bladder 10.

The ball carcass 30 comprises a ball cushion 31 and a plurality of carcass panels 32. The ball cushion 31, which is constructed to have a true roundness shape, is arranged to receive the ball pocket 20 within the ball cushion 31.

Each of the carcass panels 32 has a peripheral edge 321 and a flat bottom surface 322 defined within the peripheral edge 321, wherein the bottom surface 322 of each of the carcass panels 32 is entirely affixed to the ball cushion 31 at a position that the peripheral edge 321 of each of the carcass panels 32 is fittingly aligned with the peripheral edges 321 of the adjacent carcass panels 32 to form a roundness carcass of the sports ball in a stitch-less manner.

According to the first preferred embodiment of the present invention, the inflatable bladder 10 is made of flexible plastic materials, such as rubber, wherein the inflatable bladder 10 is adapted to be fully inflated through the valve stem 11 to form a substantially spherical shape.

Moreover, the ball pocket 20 comprises a plurality of pocket panels 22 which are overlappedly laminated with each other side by side and are treated to form an integral spherical structure of the ball pocket 20 so as to retain a true roundness shape of the inflatable bladder 10 after the inflatable bladder 10 has been inflated. Thus, the pocket panels 22 are securely attached onto the inflatable bladder 10 for embedding the inflatable bladder 10 within the ball pocket 20 in the interior cavity 21. As such, the inflatable bladder 10 is substantially enhanced in strength and thereby protected from excessive external impact.

It is worth mentioning that the pocket panels 22 of the ball pocket 20 are preferably made of thin fabric materials having a desirable materials strength so that when the pocket panels 22 are overlappedly attached on the inflatable bladder 10, the ball pocket 20 thereby formed is capable of protecting the inflatable bladder.

In order to further enhance the strength of the ball pocket 20, the ball pocket may further comprise an adhesive layer formed between the pocket panels 22 and an outer surface of the inflatable bladder 10 for ensuring effective protection of the inflatable bladder 10 by the ball pocket 20. It is important to point out that the adhesive layer is optionally in that when the inflatable bladder 10 has been fully inflated, the ball pocket 20 is nevertheless expanded to form a spherical supporting structure for protecting the inflatable bladder 10.

On the other hand, ball cushion 31 of the ball carcass 30 comprises at least a cushion layer 311 which is overlapped on the ball pocket 20 and is treated to form an integral spherical structure of the ball cushion 31, so as to provide a cushion effect for the sports ball at any point thereof. According to the first preferred embodiment of the present invention, the cushion layer 311 is made of expandable forming material which is thin when untreated, and when the cushion layer 311 is heat-treated, and preferably vulcanized, the cushion layer 311 is expanded to form a foaming cushion layer of the ball cushion 31. The cushion layer 311 will then provide a uniform cushion effect to the sports ball for ensuring uniform performance thereof when the sports ball is actually in use in a ball game. More specifically, the cushion layer 311 is made of rubber arranged when the cushion layer 311 is heat-treated, the cushion layer 311 forms a spherical foaming cushion around the ball pocket 20. Thus, the inflatable bladder 10 is substantially protected by the ball pocket 20 as well as the cushion layer 311.

The ball cushion 31 further has a plurality of panel guiders 312 which are integrally formed on an outer spherical surface 313 thereof and are shaped corresponding to contours of the carcass panels 32 to guide the carcass panels 32 affixing on the outer spherical surface 313 of the ball cushion 31. According to the first preferred embodiment of the present invention, the panel guiders 312 are formed when the cushion layer 311 is treated in a predetermined mold for forming the spherical foaming cushion, wherein the panel guiders 312 are protruded from and extended along the outer spherical surface 313 of the ball cushion 31. The panel guiders 312, being extended along the outer spherical surface 313 of the ball cushion 31, form a corresponding number of panel cavities 314 between at least two panel guiders 312, wherein the contour of the corresponding carcass panels 32 corresponds with the shape of the corresponding panel cavity 314. As such, each of the carcass panels 32 is adapted to be securely attached onto the corresponding panel cavity 314 for form the outermost layer of the sports ball of the present invention. It is worth mentioning that the carcass panels 32 are preferably made of materials which can be chemically dyed or patterned for forming an artistic appearance of the sports ball. For example, the carcass panels 32 can be made of leather or rubber.

Referring to FIG. 2 of the drawings, each of the carcass panels 32 further has a slanted edge portion 323 extended towards the peripheral edge 321 thereof, wherein a thickness of the slanted edge portion 323 of each of the carcass panels 32 is gradually reducing toward the peripheral edge 321 of the corresponding carcass panel 32. This feature of the sports ball has three advantages: first, the carcass panels 32 are uniformly attached on the ball cushion 31 to provide the uniform cushioning effect over the entire sports ball; second, since the attachment of the carcass panels 32 does not involve any stitching procedure, the carcass panels 32 can be shaped and crafted to have any cross sectional shape without needing to concern if the cross sectional shape is compatible for stitching; third, the aesthetic appearance of the sports ball can be preserved. In fact, according the first preferred embodiment of the present invention, at least one of the carcass panels 32 is cut to have a sharp corner having an acute angle to adhere on the ball cushion 31 for forming a desirable aesthetic appearance of the sports ball of the present invention.

Moreover, in order to further enhance the secure attachment between the carcass panels 32 and the ball cushion 31, the peripheral edges 321 of the carcass panels 30 are interlocked with each other to cover on the ball cushion 31 in a hidden manner, in such a manner that the carcass panels 32 are adhered on the ball cushion 31 to form the roundness ball carcass 30 in a stitch-less manner.

It is worth mentioning that as a slight alternative of the first preferred embodiment, the ball cushion 31 can comprise a plurality of cushion layers 311 overlappedly affixed to the bottom surfaces 322 of the carcass panels 32 respectively, wherein the cushion layers 311 are overlapped on the ball pocket 20 to form an integral spherical structure of the ball cushion 31, so as to provide a cushion effect for the sports ball at any point thereof.

It is particularly important at this stage to mention that the forgoing description of the sports ball of the present invention is not limited to the particular example of the first preferred embodiment, i.e. a soccer ball. Instead, the sports ball of the present invention may be specifically designed and crafted, with all the above structural limitations and features, to form other kinds of sports ball, such as a basketball or even a volley ball. With all the features and limitation of the present invention, the difference between a soccer ball and a say, basketball, may be mere the aesthetic appearance of the carcass panels 32.

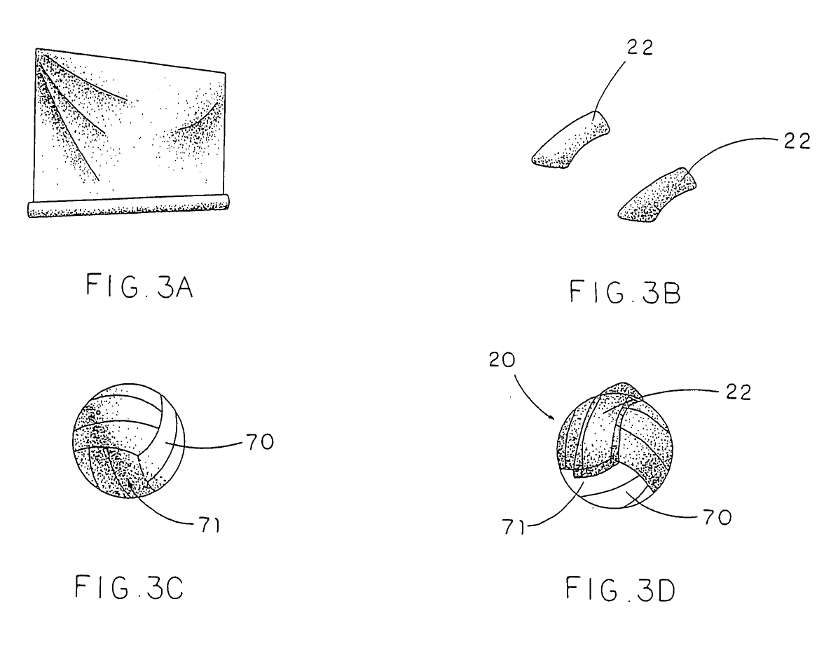

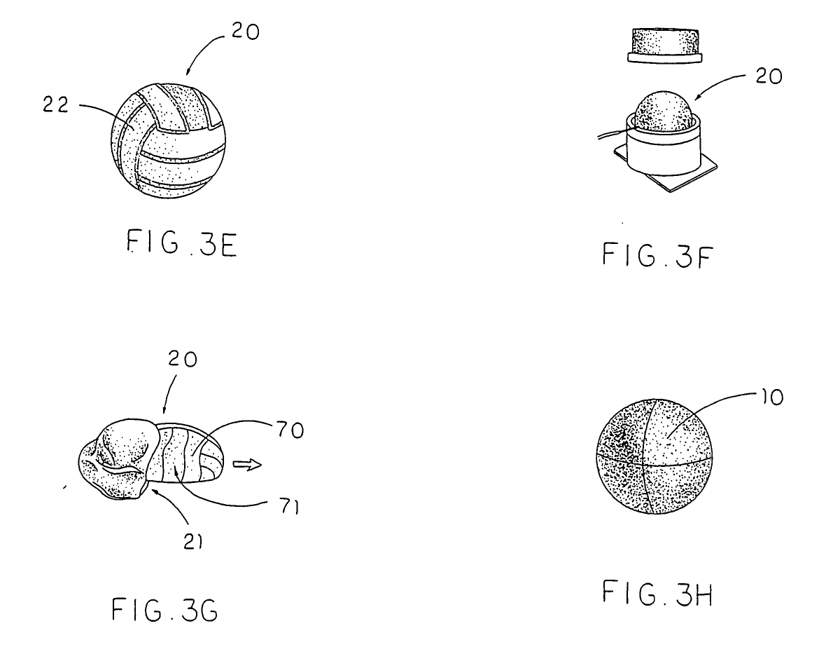

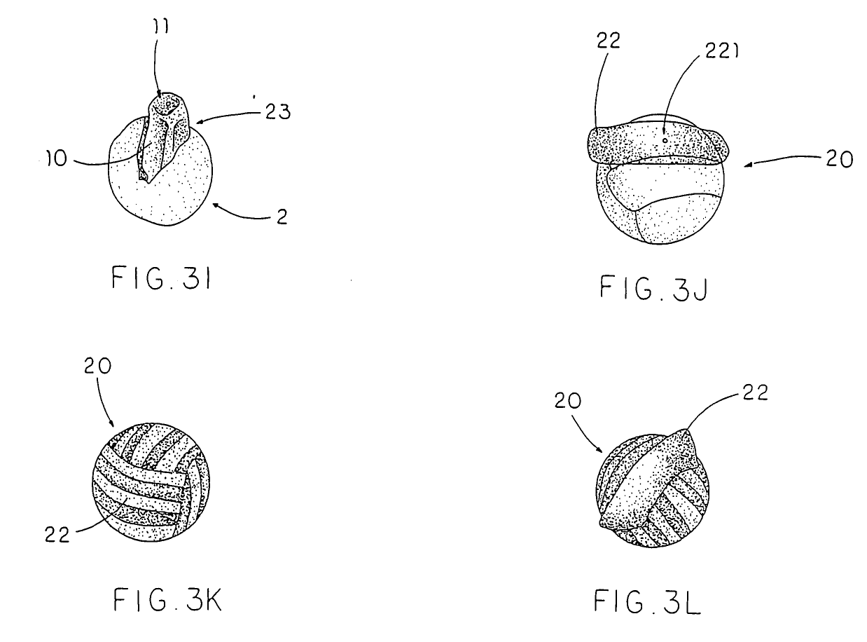

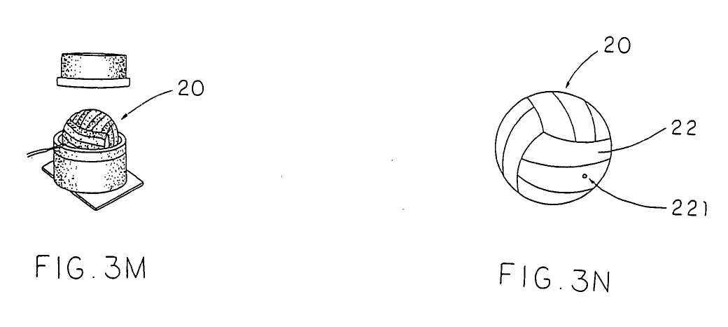

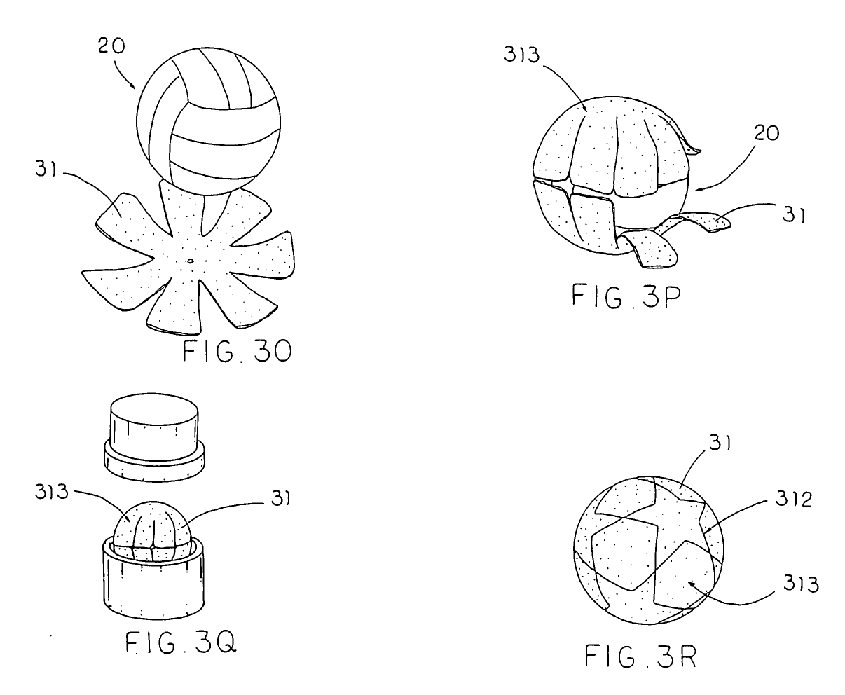

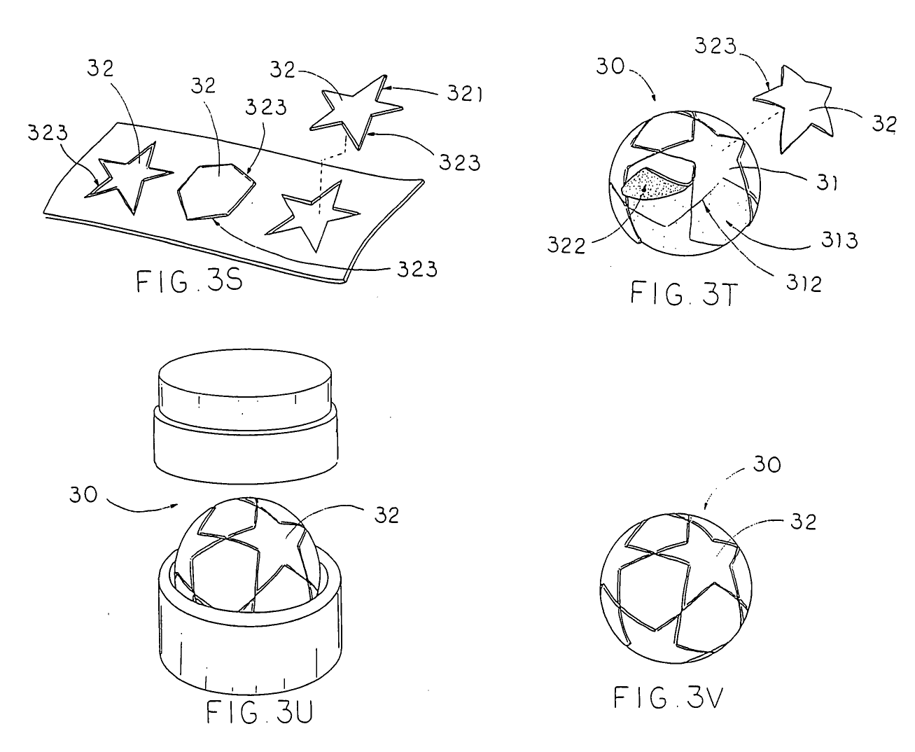

Referring to FIG. 3A to FIG. 3V of the drawings, a method of manufacturing a sports ball according to the first preferred embodiment of the present invention is illustrated, in which the method comprises the steps of:

(a) forming a ball pocket 20, which is constructed to have a true roundness, having an interior cavity 21;

(b) disposing an inflatable bladder 10, having a valve stem 11, in the ball pocket 20, wherein when the inflatable bladder 10 is inflated, the ball pocket 20 retains a true roundness shape of the inflatable bladder 10;

(c) forming a ball cushion 31, which is constructed to have a true roundness, to receive the ball pocket 20 therein; and

(d) affixing a plurality of carcass panels 32 on the ball cushion 31 to form a roundness ball carcass 30 of the sports ball in a stitch-less manner, wherein each of the carcass panels 32 having a peripheral edge 321 and a flat bottom surface 322 defined within the peripheral edge 321, wherein the bottom surface 322 of each of the carcass panels 32 is entirely affixed to the ball cushion 31 at a position that the peripheral edge 321 of each of the carcass panels 32 is fittingly aligned with the peripheral edges 321 of the adjacent carcass panels 32 to form the roundness ball carcass 30 of the sports ball.

According to the first preferred embodiment of the present invention, step (c) comprises the steps of:

(c.1) overlapping at least a cushion layer 31 on the ball pocket 20; and

(c.2) heat-treating the cushion layer 31 to form an integral spherical foaming cushion around the ball pocket 20 to provide a cushion effect for the sports ball at any point thereof. Note that the heat treatment can be performed by conventional heating machine.

Moreover, step (c.2) further comprises a step of integrally forming a plurality of panel guiders 312 on an outer spherical surface 313 thereof, wherein the panel guiders 312 are shaped corresponding to contours of the carcass panels 32 to guide the carcass panels 32 affixing on the outer spherical surface 313 of the ball cushion 31.

Step (a) further comprises the steps of:

(a.1) providing a parent bladder 70 having a true roundness shape after the parent bladder 70 is inflated;

(a.2) overlapping a plurality of pocket panels 22 on the parent bladder 70 at a position that edge portions of the pocket panels 22 are overlapped with edge portions of the adjacent pocket panels 22, wherein one of the pocket panels 22, having a valve hole 221, is remained unattached to form a first inlet opening 23 of the ball pocket 20;

(a.3) heat-treating the pocket panels 22 to integrally bond the ball panels 22 together to form a hollow round ball body having a first inlet opening 23 provided thereon;

(a.4) removing the parent bladder 70 from the hollow round ball body through the inlet opening 23 after the parent bladder 70 is deflated;

(a.5) disposing the inflatable bladder 10 in the hollow round ball body through the inlet opening 23 before the inflatable bladder 10 is inflated; and

(a.6) sealing the first inlet opening 23 with attaching the unattached pocket panel 22 at a position that the valve hole 221 is aligned with the valve stem 11 to sealedly enclose the interior cavity 21 to form a primary ball pocket 20.

In order to ensure easy removal of the parent bladder 70 and effective attachment of the pocket panels 22, step (a.2) further comprises the step of applying a removing agent on a spherical surface 71 of the parent bladder 70 and applying an adhering element on the pocket panels 22.

In order to form a slanted edge portion 323 for each of the carcass panels 32, step (d) further comprises a pre-step of pre-cutting each of the carcass panels 32 to form a slanted edge portion 323 extended towards the edge thereof, wherein a thickness of the slanted edge portion 323 of each of the carcass panels 32 is gradually reducing towards the peripheral edge 321.

It is worth mentioning that the carcass panels 32 are cut by a specifically prepared die-cut apparatus, in which each of the carcass panels 32 is first cut half-way for forming the corresponding slanted edge portion 323 and then cut thoroughly to form a carcass panel 32 having the slanted edge portion 323. In other words, the carcass panels 32 can be effectively and swiftly cut to attach on the ball cushion 31.

Moreover, step (d) further comprises a step of interlocking the peripheral edges 321 of the carcass panels 32 with each other to cover on the ball cushion 20 in a hidden manner. Thus, the attachment strength of the carcass panels 32 can be substantially enhanced.

Corresponding with the slight alternative as mentioned above, step (d) may further comprises the steps of overlappedly affixing a plurality of cushion layers 311 to the bottom surfaces 322 of the carcass panels 32 respectively, and overlapping the cushion layers 311 on the ball pocket 20 to form an integral spherical structure of the ball cushion 31 so as to provide a cushion effect for the sports ball at any point thereof.

It should be appreciated from the above disclosure that the sports ball of the present invention can be manufactured efficiently and in a cost-effective manner so as to overcome the above-mentioned shortcomings for conventional sports ball.

According to the first preferred embodiment of the present invention, step (a) further comprises the steps of:

(a.7) overlapping a plurality of pocket panels 22 onto the primary ball pocket 20 at a position that edge portions of the pocket panels 22 are overlapped with edge portions of the adjacent pocket panels 22, wherein one of the pocket panels 22, having a valve hole 221, is remained unattached to form a second inlet opening 23 of the ball pocket 20;

(a.8) heat-treating the additional pocket panels 22 to integrally bond the ball panels 22 together to form a hollow round ball body having second inlet opening 23 provided thereon;

(a.9) sealing the second inlet opening 23 with attaching the unattached pocket panel 22 at a position that the valve hole 221 is aligned with the valve stem 11 to sealedly enclose the interior cavity 21 to form a preferred ball pocket 20.

Note that step (a.7) to step (a.9) are optionally required depending on the circumstances of manufacture. Where stronger ball pocket 20 is required, step (a.7) to step (a.9) effective provide an enhance structure of the ball pocket 20. However, it is important to point out that step (a.1) to step (a.6) suffice to produce a complete ball pocket 20 with a predetermined strength.

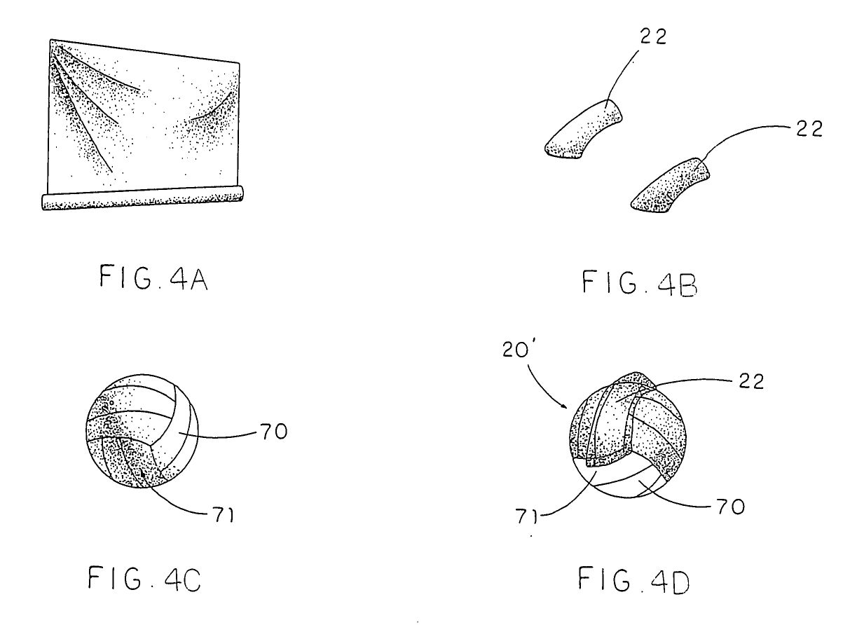

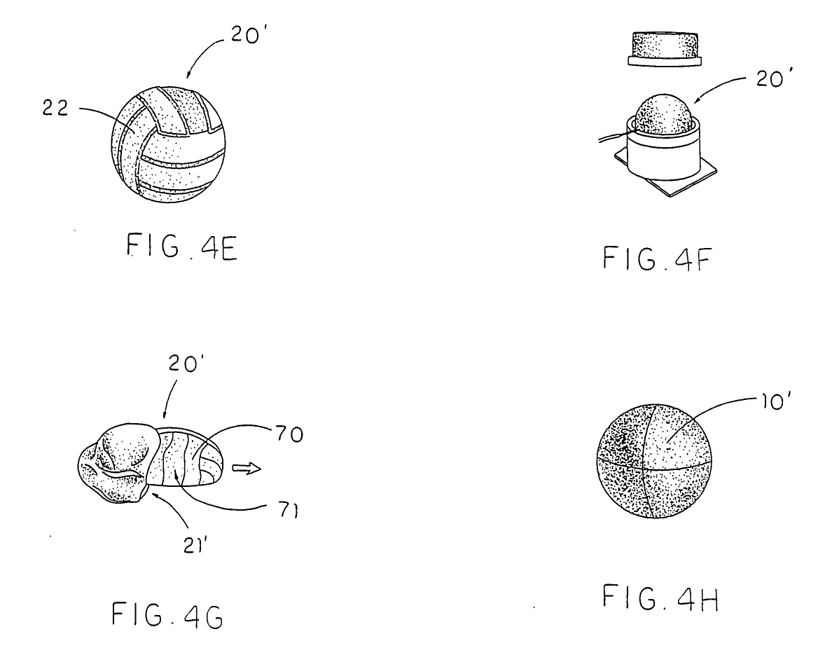

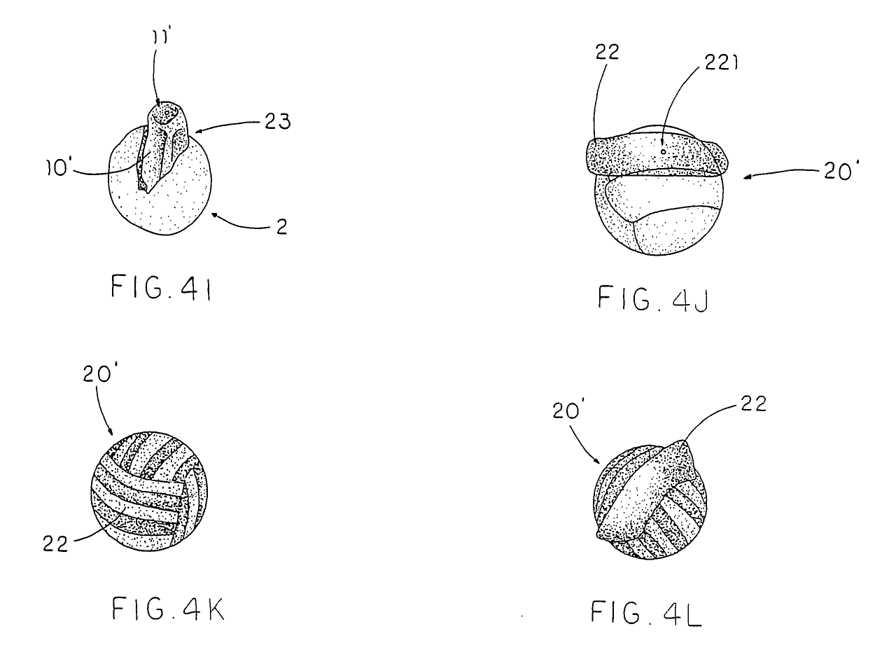

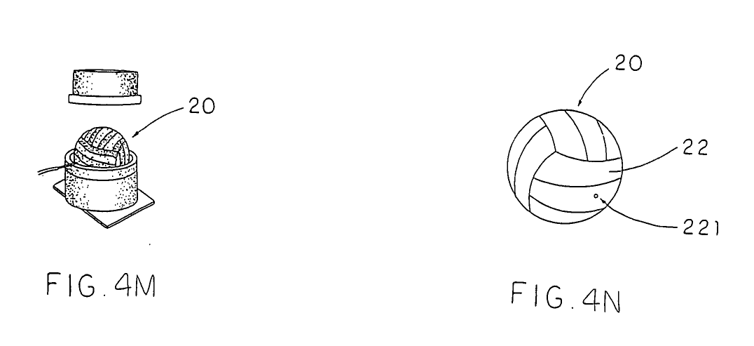

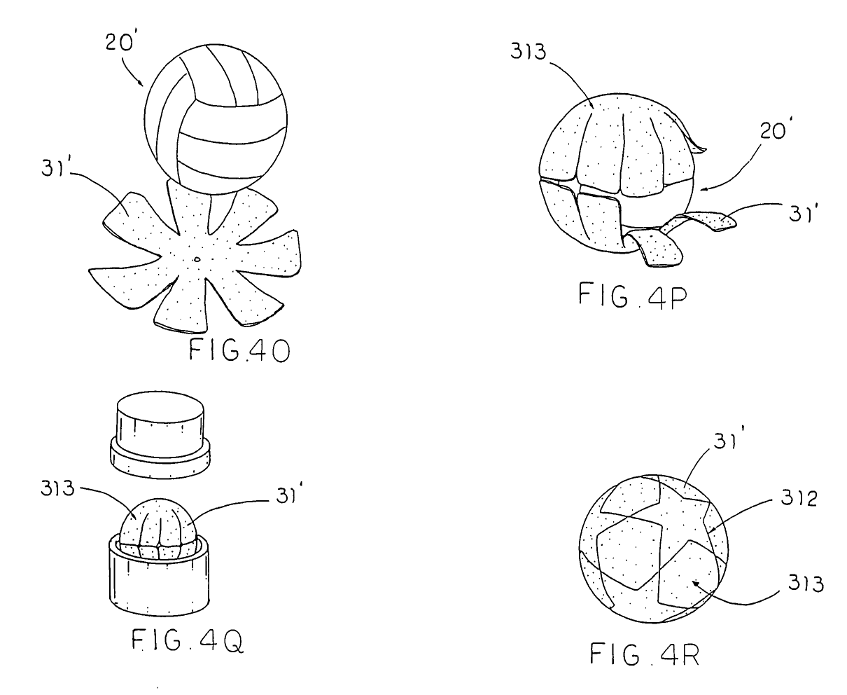

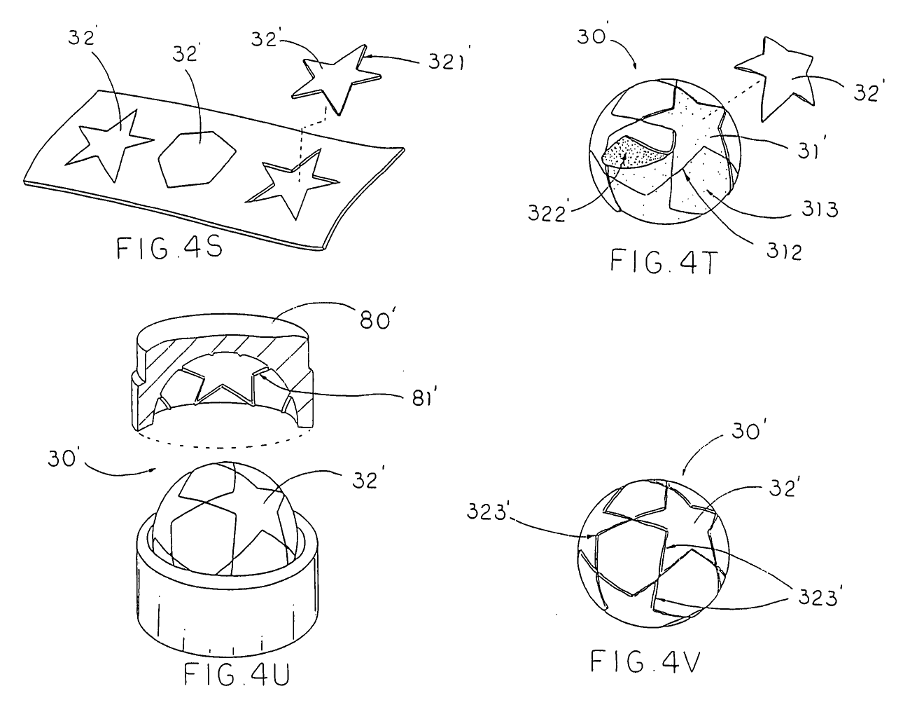

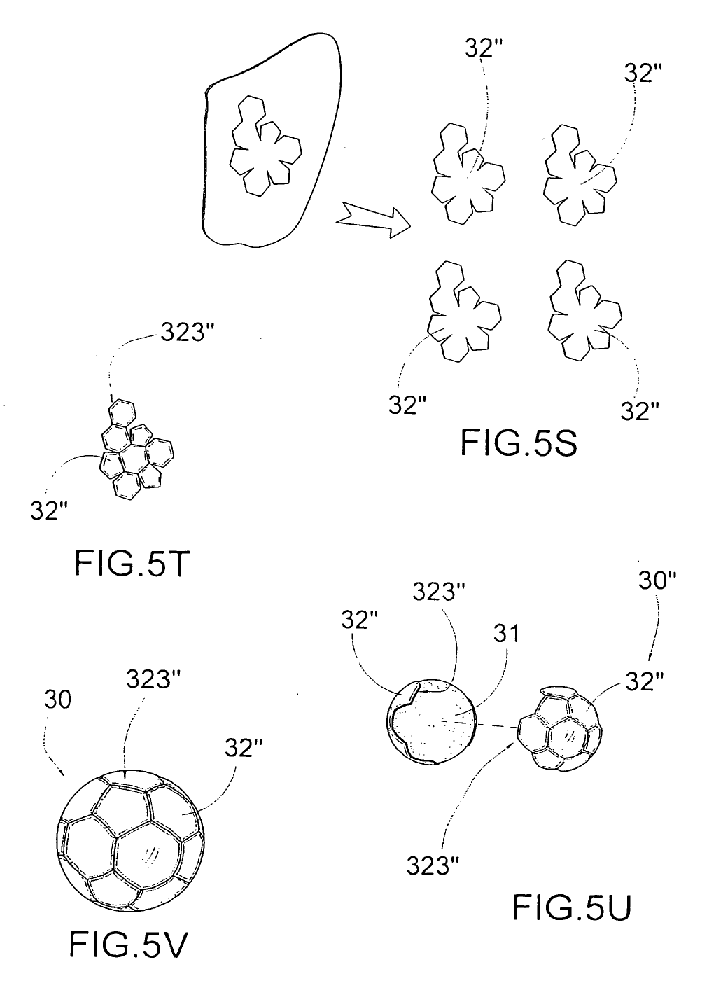

Referring to FIG. 4A to FIG. 4V of the drawings, a first alternative mode of the manufacturing method of the sports ball according to the first preferred embodiment of the present invention is illustrated. According to the alternative mode, the method of manufacturing the sports ball, comprises the steps of:

(a′) forming a ball pocket 20′, which is constructed to have a true roundness, having an interior cavity 21′;

(b′) disposing an inflatable bladder 10′, having a valve stem 11′, in the ball pocket 20′, wherein when the inflatable bladder 10′ is inflated, the ball pocket 20′ retains a true roundness shape of the inflatable bladder 10′;

(c′) forming a ball cushion 31′, which is constructed to have a true roundness, to receive the ball pocket 20′ therein; and

(d′) affixing a plurality of carcass panels 32′ on the ball cushion 31′ to form a roundness carcass 30′ of the sportsball in a stitch-less manner, wherein each of the carcass panels 32′ having a peripheral edge 321′ and a flat bottom surface 322′ defined within the peripheral edge 321′, wherein the bottom surface 322′ of each of the carcass panels 32′ is entirely affixed to the ball cushion 31′ at a position that the peripheral edge 321′ of each of the carcass panels 32′ is fittingly aligned with the peripheral edges 321′ of the adjacent carcass panels 32′ to form the roundness ball carcass 30′ of the sportsball.

Moreover, the step (d′) further comprises a pre-step of forming each of the carcass panels 32′ in a predetermined mold 80′ to form a slanted edge portion 323′ extended towards the edge thereof, wherein a thickness of the slanted edge portion 323′ of each of the carcass panels 32′ is gradually reducing towards the peripheral edge 321′, wherein the slated edge portion 323′ of the carcass panels 32′ is formed by pressing the carcass panels 32′ in the predetermined mold 80′ having a plurality of molding ribs 81′.

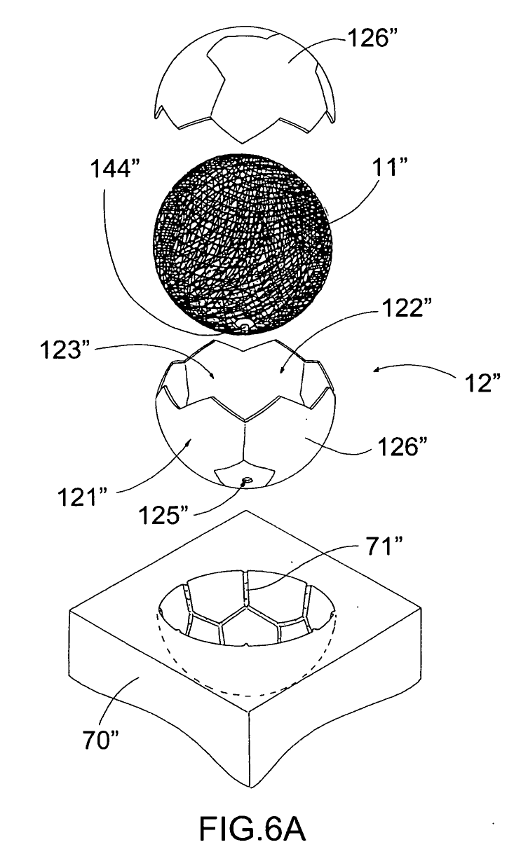

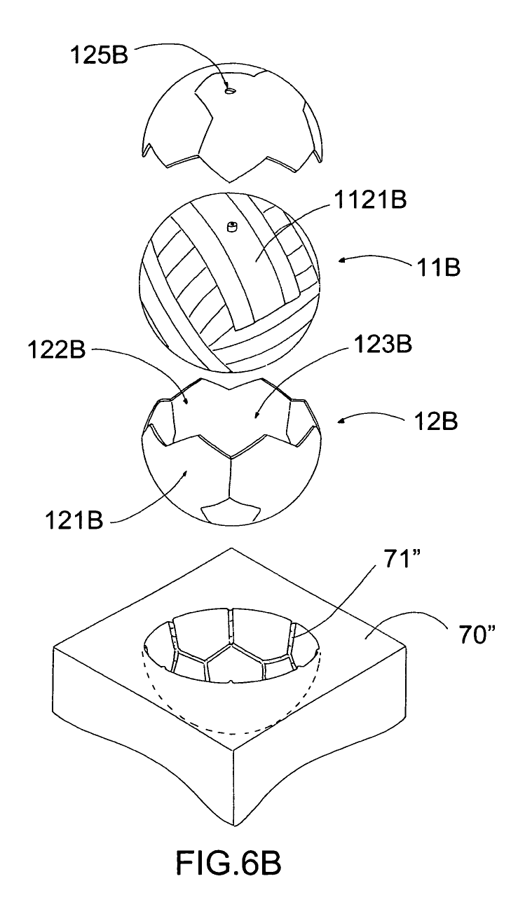

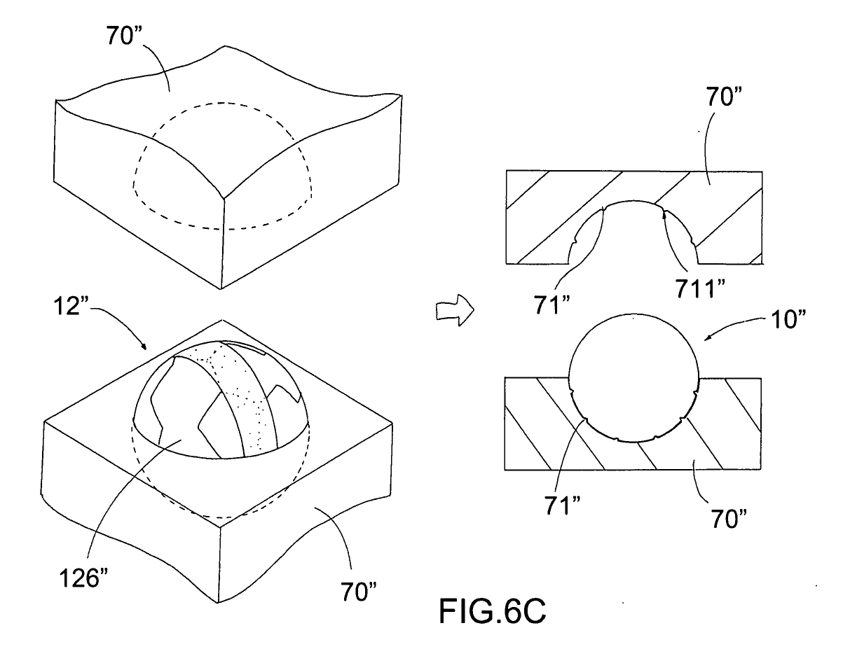

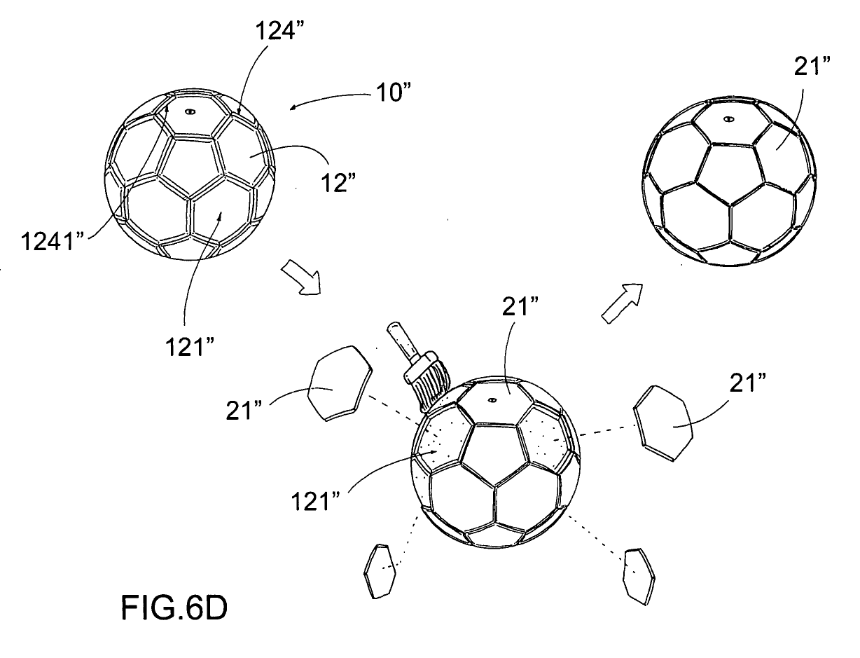

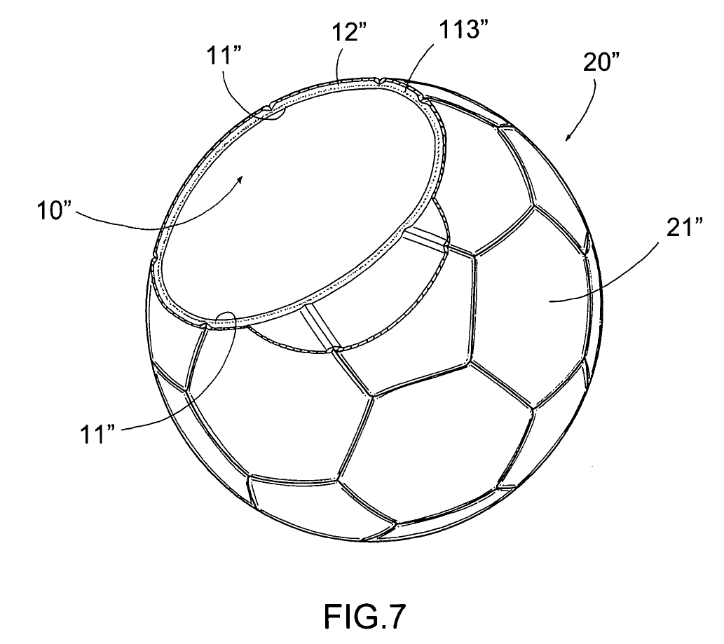

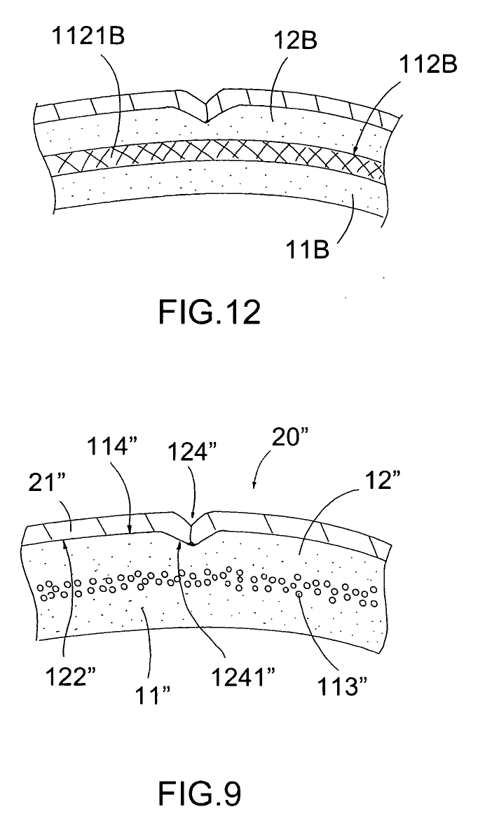

Referring to FIG. 6A, FIG. 6C, FIG. 6D and FIG. 7 to FIG. 9 of the drawings, a method of manufacturing a sports ball according to the preferred embodiment of the present invention is illustrated, in which the method comprises the steps of:

(a) providing an inflatable bladder body 11″ and a ball casing 12″ having a shape corresponding to the bladder body 11″ after being inflated;

(b) placing the bladder body 11″ and the ball casing 12″ in a casing mold 70″ at a position that the bladder body 11″ is enclosed within the ball casing 12″;

(c) vulcanizing the ball casing 12″ with heat to integrally bond the bladder body 11″ with the ball casing 12″ to form a one piece integrated barebone ball 10″ as a semi-product of the sports ball, wherein a plurality of pre-formed channels 124″ are integrally and indently formed on an outer circumferential surface 121″ of the ball casing 12; and

(d) overlappedly attaching a plurality of outer cover panels 21″ on the outer circumferential surface 121″ of the ball casing 12″ at a position that edges of each of the outer cover panels 21″ are aligned with the corresponding pre-formed channels 124″ respectively to form an outer ball layer to enclose the ball casing 12″.

Step (b) further comprises a step of aligning two or more casing panels 126″ edge-to-edge to form the ball casing 12″ such that the casing panels 126″ are aligned to enclose the bladder body 11″ in the casing mold 70″.

In step (c), the casing mold 70″ comprises a plurality of channel protrusions 71″ integrally protruded from an inner mold surface to press against the outer circumferential surface 121″ of the ball casing 12″ during vulcanization. Each of the channel protrusions 71″ has two slanted pressing surfaces 711″ such that each of the per-formed channels 124″ is formed to have two slanted sidewalls 1241″ indented on the outer circumferential surface 121″ of the ball casing 12″ during vulcanization, so that edge portions of the two neighboring outer cover panels 21″ are overlappedly attached on the slanted sidewalls 1241″ of the corresponding pre-formed channel 124″ respectively so as to be securely and fittedly attached onto the barebone ball 10″.

In step (d), the outer cover panels 21″ are securely and fittedly adhered on the outer circumferential surface 121″ of the ball casing 12″ of the barebone ball 10″.

According to the preferred embodiment of the present invention, the outer circumferential surface of the bladder body 11″ is integrated with the inner circumferential surface 122″ of the ball casing 12″ to form the one piece integrated barebone ball 10″ after vulcanization. The ball casing 12″ is made of rubber material for providing a cushion effect at any point of the barebone ball 10″ after vulcanization.

It is worth mentioning that the sports ball of the present invention can be manufactured as a soccer ball, a volley ball or even an America football. Preferably, the soccer ball is made by the above mentioned structure and its manufacturing process thereof.

Referring to FIG. 7 to FIG. 9 of the drawings, a sports ball according to a second preferred embodiment of the present invention is illustrated, in which the sports ball comprises a barebone ball 10″ and an outer ball layer 20″. Accordingly, the sports ball of the present invention is illustrated as a soccer ball.

The barebone ball 10″ comprises an inflatable bladder body 11″ and a ball casing 12″. The ball casing 12″, which is formed in an one-piece integrated structure, has an outer circumferential surface 121″, an inner circumferential surface 122″ to define an interior cavity 123″ to fittingly enclose the bladder body 11″ therein, and a plurality of pre-formed channels 124″ integrally and indently formed on the outer circumferential surface 121″, such that the ball casing 12″ and the bladder body 11″ enclosed therewithin form a one piece integrated semi-product of the sports ball.

On the other hand, the outer ball layer 20″ comprises a plurality of outer cover panels 21″ overlappedly attaching on the outer circumferential surface 121″ of the ball casing 12″ at a position that edges of each of the outer cover panels 21″ are aligned with the corresponding pre-forme channels 124″ respectively so as to fittedly attach onto the ball casing 12″.

According to the preferred embodiment of the present invention, each of the per-formed channels 124″ has two slanted sidewalls 1241″ indented on the outer circumferential surface 121″ of the ball casing 12″ such that edge portions of the two neighboring outer cover panels 21″ are overlappedly attached on the sidewalls 1241″ of the corresponding pre-formed channel 124″ respectively such that each of the outer cover panels 21″ are adapted to be fittedly attached onto the outer circumferential surface 121″ along the corresponding pre-formed channels 124″.

It is worth mentioning that an outer circumferential surface 114″ of the bladder body 11″ is integrated with the inner circumferential surface 122″ of the ball casing 12″ after the ball casing 12″ is heat-treated to form the one piece integrated semi-product of the sports ball. As a result, the ball casing 12″ and the bladder body 11″ is integrated as a one-piece body so as to possess the optimal roundness of the ball casing 12″ and the structural integrity and strength of the semi-product of the sports ball. Moreover, the ball casing 12″ is made of rubber or other soft materials (such as PVC, foaming materials etc.) for providing a cushion effect at any point of the barebone ball 10″. Since the ball casing 12″ is formed as a one-piece semi-product without involving stitching or any other mechanical connection mechanisms, the ball casing 12″ is capable of possessing a truly rounded outer shape with optimally even cushioning effect and maximal structural integrity and strength. In other words, the present invention resolves the problem of inadequate roundness and weak structural integrity of conventional sports ball. Moreover, the outer cover panels 21″ are adhered on the outer circumferential surface 121″ of the ball casing 12″ of the barebone ball 10″.

It is worth mentioning that the barebone ball 10″ can also be considered as a final product of the sports ball without the outer ball layer 20″, wherein the ball casing 12″ of the barebone ball 10″ can be considered as the carcass panels of the sports ball. Moreover, it is worth mentioning that the channels 124″ pre-formed on the barebone ball 10″ can also be used as a water repellent guiding channels when the sports ball of the present invention is played in a wet condition, such as in a raining day.

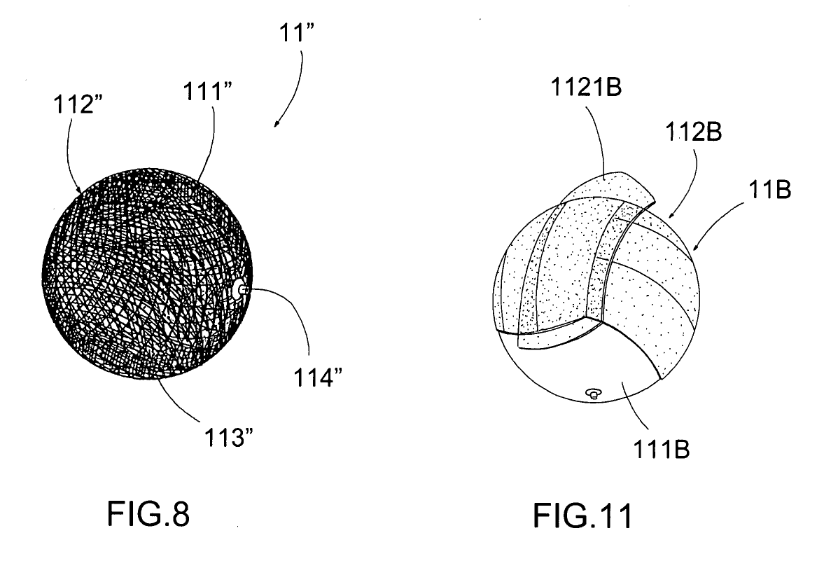

As shown in FIG. 8 of the drawings, the inflatable bladder body 11″ comprises an inflatable bladder 111″ for being popped by air inflation and an exterior web layer 112″, which is integrally attached on an outer surface of the inflatable bladder 111″, and comprises at least an elongated strengthened thread 113″ evenly wound around the outer surface of the inflatable bladder 111″ such that the web layer 112″ embraces the inflatable bladder 111″ for resisting stress and impact force applied to the inflatable bladder 111″.

In other words, the inflatable bladder body 10″, which is disposed inside the ball casing 12″, comprises a rubber made inflatable bladder 111″ and a valve stem 114″ mounted thereon wherein the ball casing 12″ has a valve hole 125″ formed thereon for aligning with the valve stem 114″. The inflatable bladder body 10″ comprises an exterior web layer 112″ integrally attached on an outer surface of the inflatable bladder 111″.

In order to enable the strengthened threads 113″ being permanently affixed on the outer surface of the inflatable bladder 111″, before winding onto the inflatable bladder 111″, the strengthened threads 113″ are coated with glue for adhering onto the outer surface of the inflatable bladder 111″ and each other. Moreover, the inflatable bladder 111″ with the adhering strengthened threads 113″ thereon are together cured by heating in a mold, so that the adhering strengthened threads 113″ will be hardened to form the exterior web layer 112″ which is permanently united with the inflatable bladder 111″ integrally.

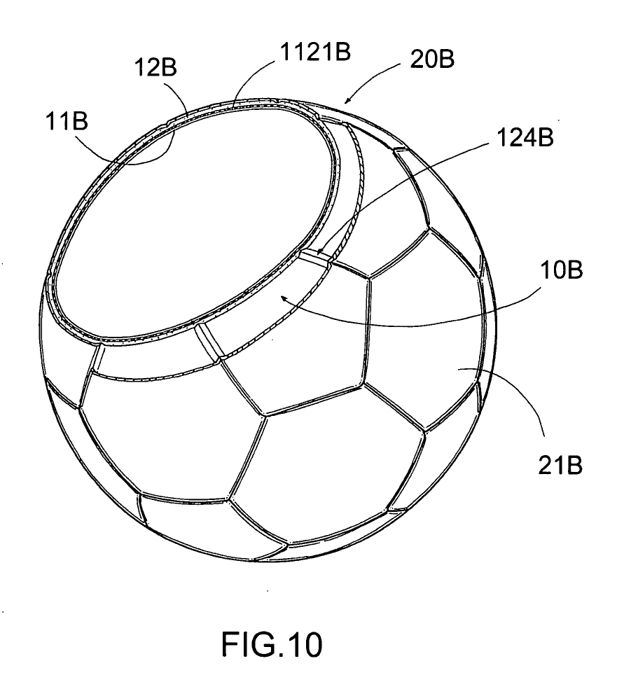

As an alternative mode shown in FIG. 1B, and FIG. 10 to FIG. 12 of the drawings, the barebone ball 10B comprises an inflatable bladder body 11B and a ball casing 12B. The ball casing 12B, which is formed in a one-piece integrated structure, has an outer circumferential surface 121B, an inner circumferential surface 122B to define an interior cavity 123B to fittingly enclose the bladder body 11B therein, and a plurality of pre-formed channels 124B integrally and indently formed on the outer circumferential surface 121B, such that the ball casing 12B and the bladder body 11B enclosed therewithin form a one piece integrated semi-product of the sports ball.

On the other hand, the outer ball layer 20B comprises a plurality of outer cover panels 21B overlappedly attaching on the outer circumferential surface 121B of the ball casing 12B at a position that edges of each of the outer cover panels 21B are aligned with the corresponding pre-formed channels 124B respectively so as to fittedly attach onto the ball casing 12B.

Moreover, the bladder body 11B comprises an inflatable bladder 111B for being popped by air inflation and a construction ball pocket 112B, which is made of fabric material and constructed to have a true roundness shape, having an interior receiving cavity defined therein to sealedly receive the inflatable bladder 111B, such that the construction ball pocket 112B is arranged to retain a true roundness shape of the inflatable bladder 111B after the inflatable bladder 111B is inflated. According to the preferred embodiment, the inflatable bladder 111B is made of rubber or the like that is capable of being inflated with a compression air at a predetermined pressure for popping up and supporting the ball casing 12B.

The construction ball pocket 112B comprises a plurality of ball pocket leaves 1121B integrally connected with each other. Practically, the fabric made construction ball pocket 112B is able to form a spherical body that the construction ball pocket 112B is constructed to have a true roundness shape so as to retain a maximum diameter of the inflatable bladder 111B after it is inflated.

The construction ball pocket 112B is preferred to be made of fabric material having a durability, stretchability and adhesiveablility. Preferably, the construction ball pocket 112B can be made of a mixture fabric mixed with cotton and polyester because the cotton has a good stretchability and is able to absorb adhesive material and the polyester is durable and has a strong strength that is able to resist strain when the inflatable bladder 111B is inflated.

The inflatable bladder 111B is disposed in the construction ball pocket 112B which has a size slightly bigger than the inflatable bladder 111B in such a manner that when the inflatable bladder 111B is inflated, an outer spherical surface of the inflatable bladder 111B is preferred to be slightly spaced apart from an inner spherical surface of the construction ball pocket 112B to form an air cushion layer therebetween. The air cushion layer is adapted for providing a cushion effect for the sports ball to provide softness for the sports ball and tolerate heavier impact thereon.

It is worth mentioning that the barebone ball 10″ in this second preferred embodiment may further an inner lining layer integrally formed between the ball casing 12″ and the inflatable bladder body 11″ for further reinforcing a strength of the barbone ball 10″.

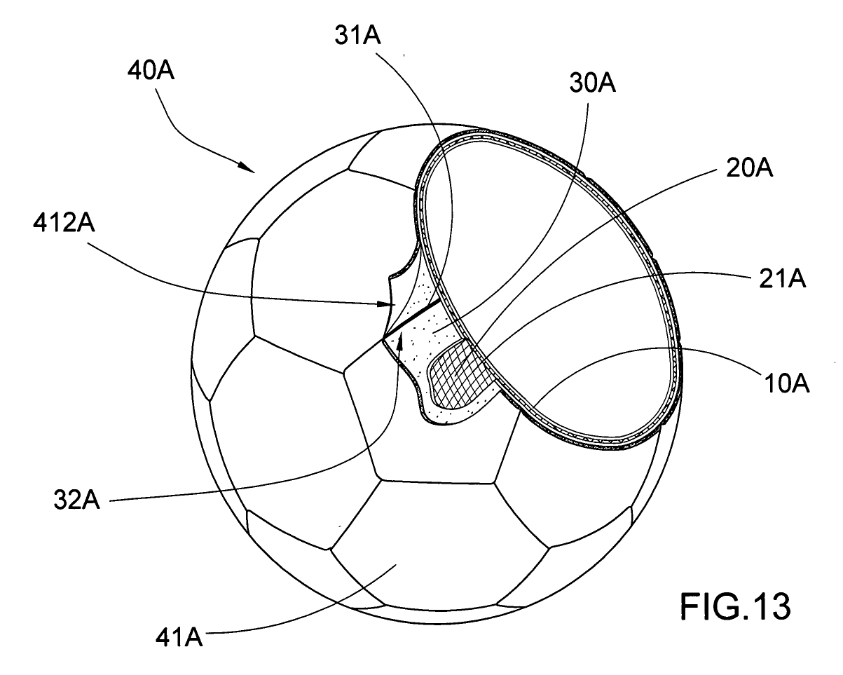

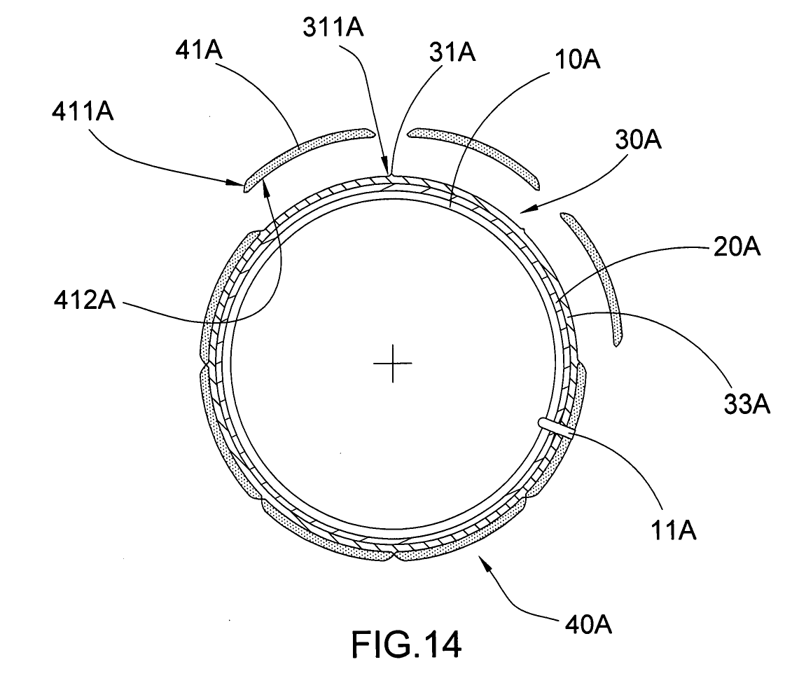

Referring to FIG. 13 to FIG. 14 of the drawings, a sports ball according to a third preferred embodiment of the present invention is illustrated, in which the sports ball comprises an inflatable bladder 10A having a valve stem 11A extended therefrom, an exterior web layer 20A, a ball cushion 30A, and a ball carcass 40A.

The exterior web layer 20A is integrally attached on an outer surface of the inflatable bladder 10A, and comprises at least an elongated strengthened thread 21A evenly wound around the outer surface of the inflatable bladder 10A such that the web layer 20A embraces the inflatable bladder 10A for resisting stress and impact force applied to the inflatable bladder 10A.

The ball cushion 30A, which is constructed to have a true roundness shape, is arranged to receive the exterior web layer 20A and the inflatable bladder 10A therein, wherein the ball cushion 30A further has a plurality of panel guidelines 31A protruded from an outer surface of the ball cushion 30A to define a predetermined number of guiding contours 32A between at least two adjacent panel guidelines 31A.

The ball carcass 40A comprises a plurality of carcass panels 41A, wherein each of the carcass panels 41A has a peripheral edge 411A and a flat bottom surface 412A defined within the peripheral edge 411A, wherein the bottom surface 412A of each of the carcass panels 41A is entirely affixed to the ball cushion 30A at a position that the peripheral edge 411A of each of the carcass panels 41A is fittingly aligned with the corresponding panel guideline 31A so as to fittedly affixed on the corresponding guiding contours 32A to form a roundness carcass of the sportsball in a stitch-less manner.

According to the third preferred embodiment of the present invention, each of the panel guidelines 31A has two slanted sidewalls 311A such that peripheral edges 411A of the two neighboring carcass panels 41A are overlappedly attached on the ball cushion 30A as guided by the two slanted sidewalls 311A.

In order to enable the strengthened threads 21A to be permanently affixed on the outer surface of the inflatable bladder 10A, before winding onto the inflatable bladder 10A, the strengthened threads 21A are coated with glue for adhering onto the outer surface of the inflatable bladder 10A and each other. Moreover, the inflatable bladder 10A with the adhering strengthened threads 21A wound thereon are together cured by heating in a predetermined mold, so that the adhering strengthened threads 21A will be hardened to form the exterior web layer 20A which is permanently united with the inflatable bladder 10A integrally.

Furthermore, the ball cushion 30A further comprises at least a cushion layer 33A which is overlapped on the exterior web layer 20A and is treated to form an integral spherical structure, so as to provide a cushion effect for the sports ball at any point thereof, wherein the panel guidelines 31A are protruded from the cushion layer 33A for guiding attachment of the carcass panels 41A.

According to the third preferred embodiment of the present invention, the cushion layer 33A is made of expandable foaming material which is thin when untreated, and when the cushion layer 33A is heat-treated, and preferably vulcanized, the cushion layer 33A is expanded to form a foaming cushion layer 33A of the ball cushion 30A. The cushion layer 33A will then provide a uniform cushion effect to the sports ball for ensuring uniform performance thereof when the sports ball is actually in use in a ball game. More specifically, the cushion layer 33A is made of rubber arranged when the cushion layer 33A is heat-treated, the cushion layer 33A forms a spherical foaming cushion around the exterior web layer 20A and the inflatable ball bladder 10A.

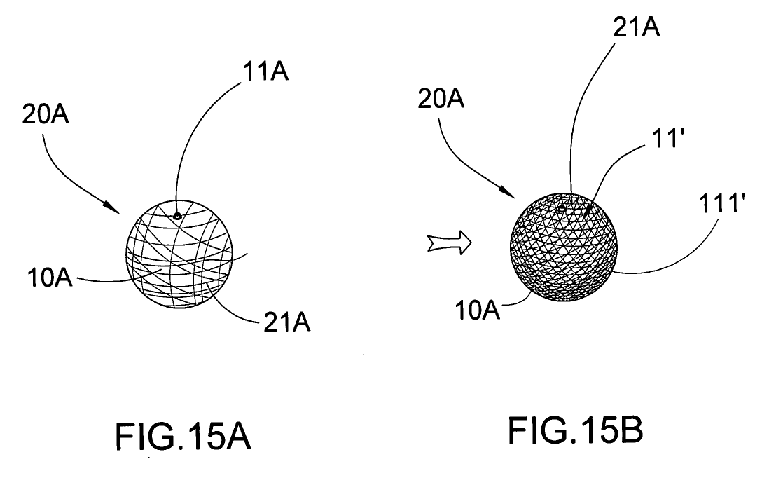

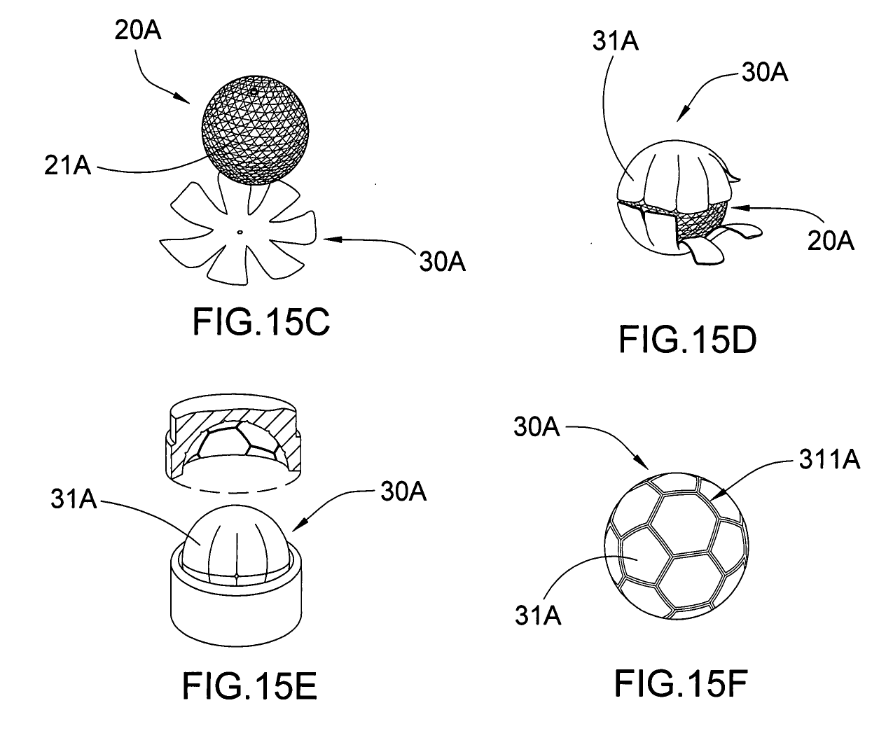

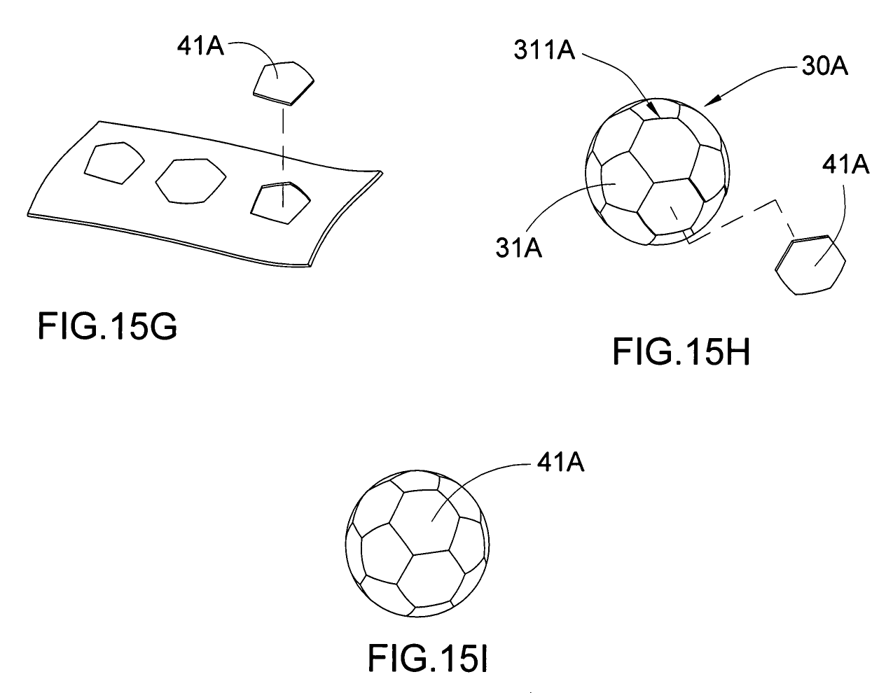

Referring to FIG. 15A to FIG. 151 of the drawings, a method of manufacturing a sports ball according to the preferred embodiment of the present invention is illustrated, in which the method comprises the steps of:

(a) providing an inflatable bladder 10A;

(b) forming an exterior web layer 20A on the inflatable bladder 10A;

(c) forming a ball cushion 30A on the inflatable bladder 10A in such a manner that the exterior web layer 20A is sandwiched between the inflatable bladder 10A and the ball cushion 30A;

(d) forming a plurality of panel guidelines 31A on an outer surface of the ball cushion 30A to define a predetermined number of guiding contours 32A between at least two adjacent panel guidelines 31A; and

(e) affixing a plurality of carcass panels 41A on the ball cushion 30A to form a roundness ball carcass 40A of the sports ball in a stitch-less manner, wherein each of the carcass panels 40A having a peripheral edge 411A and a flat bottom surface 412A defined within the peripheral edge 411A, wherein the bottom surface 412A of each of the carcass panels 41A is entirely affixed to the ball cushion 30A at a position that the peripheral edge 411A of each of the carcass panels 41A is fittingly aligned with the corresponding panel guideline 31A on a corresponding guideline contour 32A to form the roundness ball carcass 40A of the sports ball.

In this second preferred embodiment, step (b) comprises the steps of winding at least one elongated strengthened thread 21A evenly around the outer surface of the inflatable bladder 10A to form a web layer 20A embracing the inflatable bladder 10A for resisting stress and impact force applied to the inflatable bladder 10A, and heat treating the exterior web layer 20A attached on an outer surface of said inflatable bladder 10A so as to form an integral exterior web layer 20A on the inflatable bladder 10A.

Moreover, step (c) comprises the steps of:

(c.1) overlapping at least a cushion layer 33A on the exterior web layer 20A; and

(c.2) heat-treating the cushion layer 33A to form an integral spherical foaming cushion around the exterior web layer 20A to provide a cushion effect for the sports ball at any point thereof. Note that the heat treatment can be performed by conventional heating machine.

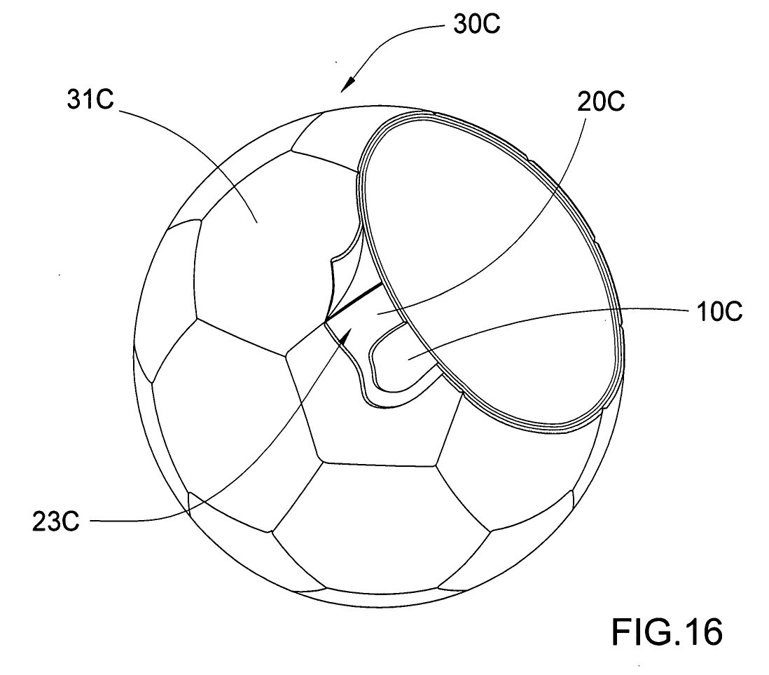

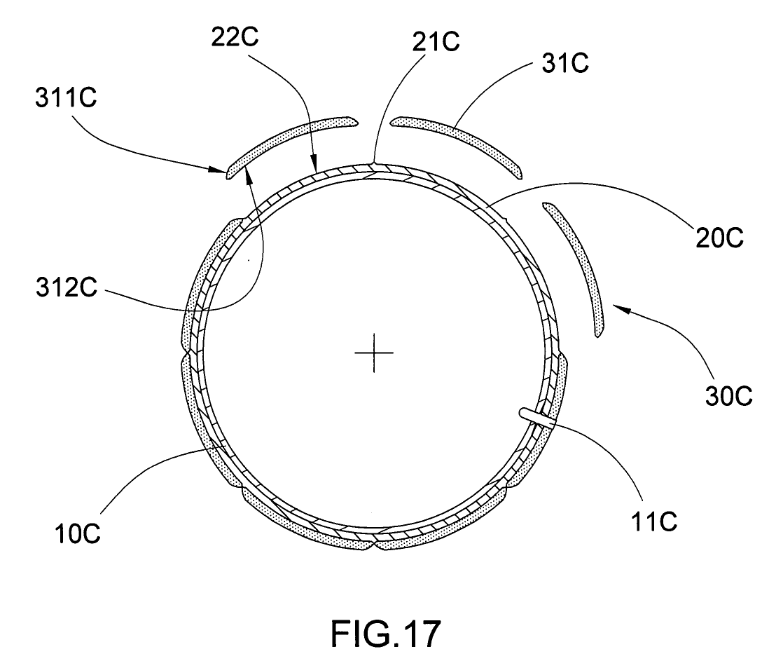

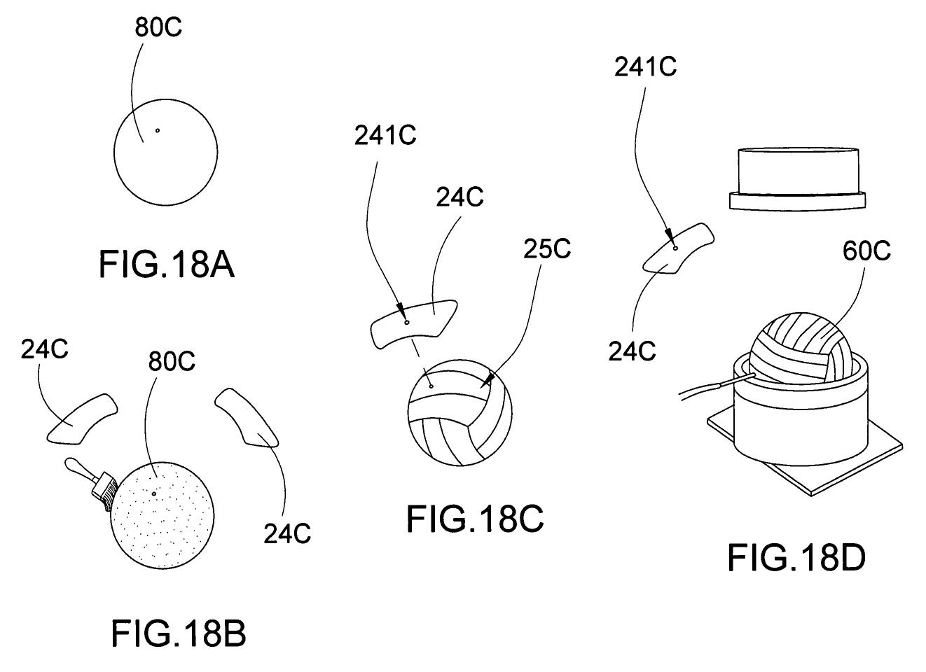

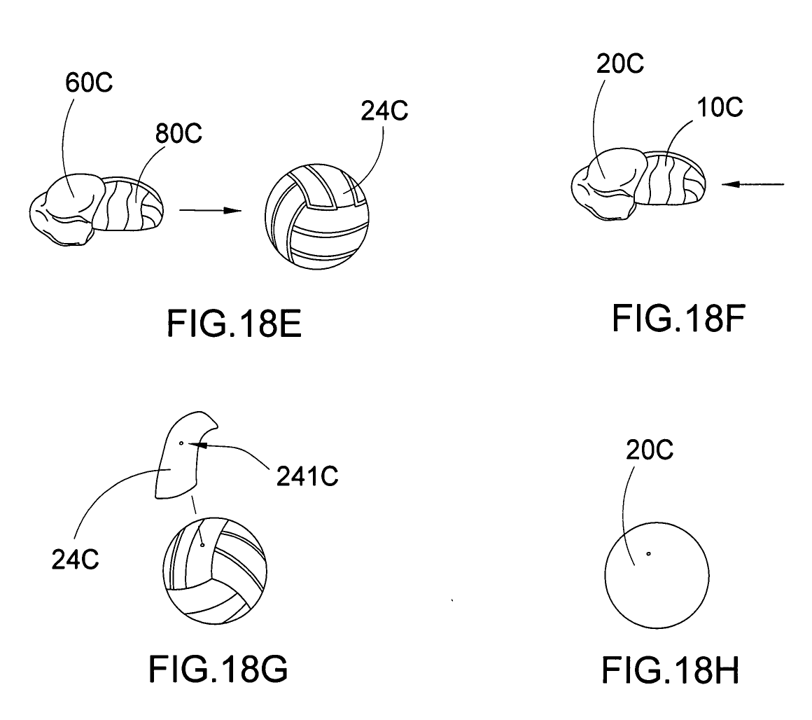

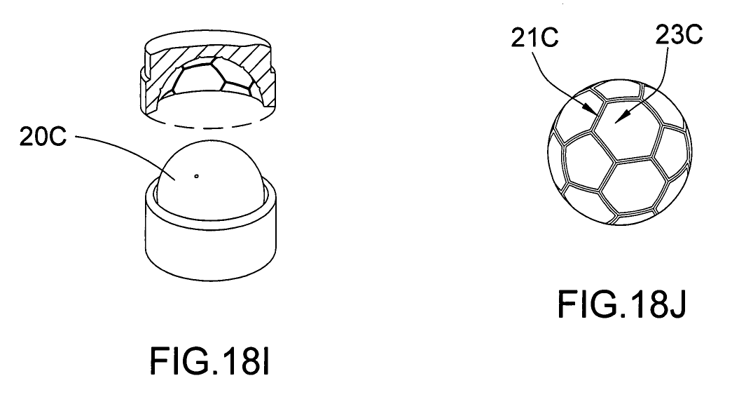

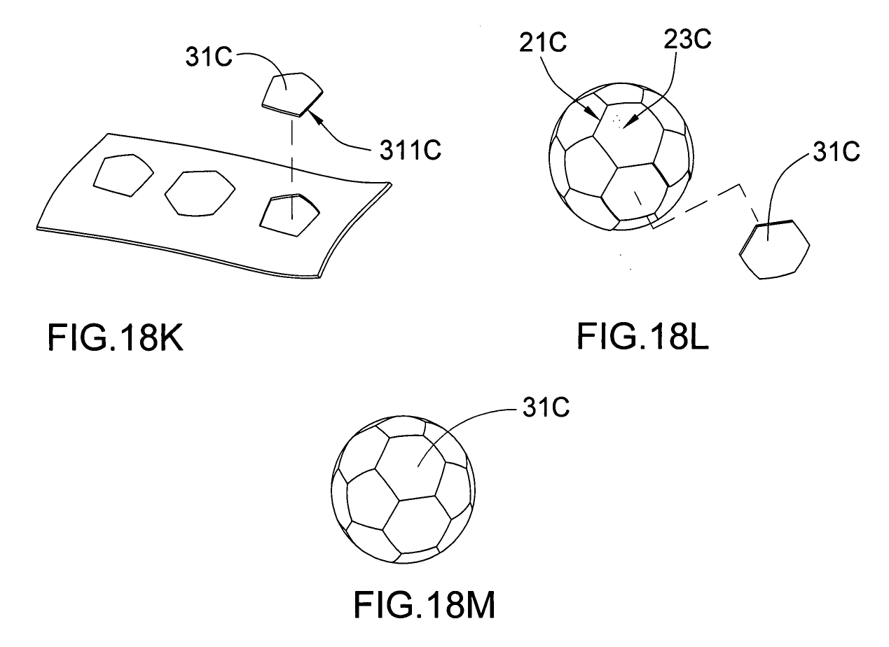

Referring to FIG. 16 to FIG. 17, and FIG. 18A to FIG. 18M of the drawings, a sports ball according to a fourth preferred embodiment of the present invention is illustrated, in which the sports ball comprises an inflatable bladder 10C having a valve stem 11C extended therefrom, a ball pocket 20C, and a ball carcass 30C.

The ball pocket 20C is constructed to have a true roundness shape, and has an interior cavity receiving the inflatable bladder 10C therein, wherein when the inflatable bladder 10C is inflated, the ball pocket 20C retains a true roundness shape of the inflatable bladder 10C, wherein the ball pocket 20C has a plurality of panel guidelines 21C protruded from an outer surface 22C of the ball pocket 20C to define a predetermined number of guiding contours 23C between at least two adjacent panel guidelines 21C.

The ball carcass 30C comprises a plurality of carcass panels 31C, wherein each of the carcass panels 31C has a peripheral edge 311C and a flat bottom surface 312C defined within the peripheral edge 311C, wherein the bottom surface 312C of each of the carcass panels 31C is entirely affixed to the ball pocket 20C at a position that the peripheral edge 311C of each of the carcass panels 31C is fittingly aligned with the corresponding panel guidelines 21C so as to fittedly affix on the corresponding guiding contours 23C to form a roundness carcass of the sportsball in a stitch-less manner.

According to the fourth preferred embodiment of the present invention, the ball pocket 20C comprises a plurality of pocket panels 24C which are overlappedly laminated with each other in a side-by-side manner, and are treated to form an integral spherical structure of the ball pocket 20C so as to retain a true roundness shape of the inflatable bladder 10C after the inflatable bladder 10C is inflated.

It is worth mentioning that the panel guidelines 21C are integrally protruded from an outer spherical surface 22C of the ball pocket 20C, and are shaped to correspond to contours of the corresponding carcass panels 31C so as to guide the carcass panels 31C affixing on the outer spherical surface 22C of the ball pocket 20C.

Each of the carcass panels 31C further has a slanted edge portion 311C extended towards the peripheral edge thereof, wherein a thickness of the slanted edge portion 311C of each of the carcass panels 31C is gradually reducing toward the peripheral edge of the corresponding carcass panel 31C, wherein each of the peripheral edges is attached to the corresponding panel guideline 21C.

Referring to FIG. 18A to FIG. 18M of the drawings, a method of manufacturing a sports ball according to a fourth preferred embodiment of the present invention is illustrated, in which the method comprises the steps of:

(a) forming a ball pocket 20C, which is constructed to have a true roundness, having an interior cavity, wherein the ball pocket 20C has a plurality of panel guidelines 21C protruded from an outer spherical surface 22C of the ball pocket 20C to define a predetermined number of guiding contours 23C between at least two adjacent panel guidelines 23C;

(b) disposing an inflatable bladder 10C, having a valve stem 11C, in the ball pocket 20C, wherein when the inflatable bladder 10C is inflated, the ball pocket 20C retains a true roundness shape of the inflatable bladder 10C; and

(c) affixing a plurality of carcass panels 31C on the ball pocket 20C to form a roundness ball carcass 30C of the sports ball in a stitch-less manner, wherein each of the carcass panels 31C has a peripheral edge 311C and a flat bottom surface 312C defined within the peripheral edge 311C, wherein the bottom surface 312C of each of the carcass panels 31C is entirely affixed to the ball pocket 20C at a position that the peripheral edge 311C of each of the carcass panels 31C is fittingly aligned with the peripheral edges 311C of the adjacent carcass panels 31C on a corresponding guideline contour 23C to form the roundness ball carcass 30C of the sports ball.

According to the fourth preferred embodiment of the present invention, step (a) comprises the steps of:

(a.1) providing a parent bladder 80C having a true roundness shape after the parent bladder is inflated;

(a.2) overlapping a plurality of pocket panels 24C on the parent bladder 80C at a position that edge portions of the pocket panels 24C are overlapped with edge portions of the adjacent pocket panels 24C, wherein one of the pocket panels 24C, having a valve hole 241C, is remained unattached to form a first inlet opening 25C of the ball pocket 20C;

(a.3) heat-treating the pocket panels 24C to integrally bond the pocket panels 24C together to form a hollow round ball body 60C having a first inlet opening 25C provided thereon;

(a.4) removing the parent bladder 80C from the hollow round ball body 60C through the inlet opening 25C after the parent bladder 80C is deflated;

(a.5) disposing the inflatable bladder 10C in the hollow round ball body 60C through the inlet opening 25C before the inflatable bladder 10C is inflated;

(a.6) sealing the first inlet opening 25C with attaching the unattached pocket panel 24C at a position that the valve hole 241C is aligned with the valve stem 11C to sealedly enclose the interior cavity to form a primary ball pocket 20C; and

(a.7) forming a plurality of panel guidelines 21C on the outer spherical surface 22C of the ball pocket 20C in a predetermined mold to define a predetermined number of guiding contours 23C between at least two adjacent panel guidelines 21C.

Moreover, step (a.2) further comprises a step of applying a removing agent on a spherical surface of the parent bladder 80C and applying an adhering element on the pocket panels 24C.

The step (d) further comprises a pre-step of pre-cutting each of the carcass panels 31C to form a slanted edge portion 311C extended towards the edge thereof, wherein a thickness of the slanted edge portion 311C of each of the carcass panels 31C is gradually reducing towards the peripheral edge.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sports ball, comprising:
an inflatable bladder having a valve stem extended therefrom;
a ball pocket, which is constructed to have a true roundness shape, having an interior cavity receiving said inflatable bladder therein, wherein when said inflatable bladder is inflated, said ball pocket retains a true roundness shape of said inflatable bladder, wherein said ball pocket has a plurality of panel guidelines protruded from an outer surface of said ball pocket to define a predetermined number of guiding contours between at least two adjacent panel guidelines; and
a ball carcass which comprises a plurality of carcass panels, wherein each of said carcass panels having a peripheral edge and a flat bottom surface defined within said peripheral edge, wherein said bottom surface of each of said carcass panels is entirely affixed to said ball pocket at a position that said peripheral edge of each of said carcass panels is fittingly aligned with said corresponding panel guidelines so as to fittedly affix on said corresponding guiding contours to form a roundness carcass of said sportsball in a stitch-less manner.

2. The sports ball, as recited in claim 1, wherein said ball pocket comprises a plurality of pocket panels which are overlappedly laminated with each other in a side-by-side manner, and are treated to form an integral spherical structure of said ball pocket so as to retain a true roundness shape of said inflatable bladder after said inflatable bladder is inflated.

3. The sports ball, as recited in claim 2, wherein said panel guidelines are integrally protruded from an outer spherical surface of said ball pocket, and are shaped to correspond to contours of said corresponding carcass panels so as to guide said carcass panels affixing on said outer spherical surface of said ball pocket.

4. The sports ball, as recited in claim 3, wherein each of said carcass panels further has a slanted edge portion extended towards said peripheral edge thereof, wherein a thickness of said slanted edge portion of each of said carcass panels is gradually reducing toward said peripheral edge of said corresponding carcass panel, wherein each of said peripheral edges is attached to said corresponding panel guideline.

5. A method of manufacturing a sports ball, which comprises the steps of:
(a) forming a ball pocket, which is constructed to have a true roundness, having an interior cavity, wherein said ball pocket has a plurality of panel guidelines protruded from an outer spherical surface of said ball pocket to define a predetermined number of guiding contours between at least two adjacent panel guidelines;
(b) disposing an inflatable bladder, having a valve stem, in said ball pocket, wherein when said inflatable bladder is inflated, said ball pocket retains a true roundness shape of said inflatable bladder; and
(c) affixing a plurality of carcass panels on said ball pocket to form a roundness ball carcass of said sports ball in a stitch-less manner, wherein each of said carcass panels has a peripheral edge and a flat bottom surface defined within said peripheral edge, wherein said bottom surface of each of said carcass panels is entirely affixed to said ball pocket at a position that said peripheral edge of each of said carcass panels is fittingly aligned with said peripheral edges of said adjacent carcass panels on a corresponding guideline contour to form said roundness ball carcass of said sports ball.

6. The method, as recited in claim 5, wherein said step (a) comprises said steps of:
(a.1) providing a parent bladder having a true roundness shape after said parent bladder is inflated;
(a.2) overlapping a plurality of pocket panels on said parent bladder at a position that edge portions of said pocket panels are overlapped with edge portions of said adjacent pocket panels, wherein one of said pocket panels, having a valve hole, is remained unattached to form a first inlet opening of said ball pocket;
(a.3) heat-treating said pocket panels to integrally bond said ball panels together to form a hollow round ball body having a first inlet opening provided thereon;
(a.4) removing said parent bladder from said hollow round ball body through said inlet opening after said parent bladder is deflated;
(a.5) disposing said inflatable bladder in said hollow round ball body through said inlet opening before said inflatable bladder is inflated;
(a.6) sealing said first inlet opening with attaching said unattached pocket panel at a position that said valve hole is aligned with said valve stem to sealedly enclose said interior cavity to form a primary ball pocket; and
(a.7) forming a plurality of panel guidelines on said outer spherical surface of said ball pocket in a predetermined mold to define a predetermined number of guiding contours between at least two adjacent panel guidelines.

7. The method, as recited in claim 6, wherein said step (a.2) further comprises a step of applying a removing agent on a spherical surface of said parent bladder and applying an adhering element on said pocket panels.

8. The method, as recited in claim 6, wherein said step (d) further comprises a pre-step of pre-cutting each of said carcass panels to form a slanted edge portion extended towards said edge thereof, wherein a thickness of said slanted edge portion of each of said carcass panels is gradually reducing towards said peripheral edge.

9. The method, as recited in claim 7, wherein said step (d) further comprises a pre-step of pre-cutting each of said carcass panels to form a slanted edge portion extended towards said edge thereof, wherein a thickness of said slanted edge portion of each of said carcass panels is gradually reducing towards said peripheral edge.

10. A sportsball, comprising:
an inflatable bladder having a valve stem extended therefrom;
an exterior web layer which is integrally attached on an outer surface of said inflatable bladder, and comprises at least an elongated strengthened thread evenly wound around said outer surface of said inflatable bladder such that said web layer embraces said inflatable bladder for resisting stress and impact force applied to said inflatable bladder;
a ball cushion, which is constructed to have a true roundness shape, receiving said ball exterior web layer and said inflatable bladder therein, wherein said ball cushion further has a plurality of panel guidelines protruded from an outer surface of said ball cushion to define a predetermined number of guiding contours between at least two adjacent panel guidelines; and
a ball carcass which comprises a plurality of carcass panels, wherein each of said carcass panels having a peripheral edge and a flat bottom surface defined within said peripheral edge, wherein said bottom surface of each of said carcass panels is entirely affixed to said ball cushion at a position that said peripheral edge of each of said carcass panels is fittingly aligned with said corresponding panel guidelines so as to fittedly affixed on said corresponding guiding contours to form a roundness carcass of said sportsball in a stitch-less manner.

11. The sports ball, as recited in claim 10, wherein each of said panel guidelines has two slanted sidewalls such that peripheral edges of said two neighboring carcass panels are overlappedly attached on said ball cushion as guided by said two slanted sidewalls.

12. The sports ball, as recited in claim 11, wherein said strengthened threads are coated with glue for adhering onto said outer surface of said inflatable bladder and each other, wherein said inflatable bladder with said adhering strengthened threads wound thereon are together cured by heating in a predetermined mold, so that said adhering strengthened threads is hardened to form said exterior web layer which is permanently united with said inflatable bladder integrally.

13. The sports ball, as recited in claim 11, wherein said ball cushion further comprises at least a cushion layer which is overlapped on said exterior web layer and is treated to form an integral spherical structure, so as to provide a cushion effect for said sports ball at any point thereof, wherein said panel guidelines are protruded from said cushion layer for guiding attachment of said carcass panels.

14. The sports ball, as recited in claim 12, wherein said ball cushion further comprises at least a cushion layer which is overlapped on said exterior web layer and is treated to form an integral spherical structure, so as to provide a cushion effect for said sports ball at any point thereof, wherein said panel guidelines are protruded from said cushion layer for guiding attachment of said carcass panels.

15. The sports ball, as recited in claim 13, wherein said cushion layer is made of expandable foaming material which is thin when untreated, and when said cushion layer is heat-treated and vulcanized, said cushion layer is expanded to form a foaming cushion layer of said ball cushion.

16. The sports ball, as recited in claim 14, wherein said cushion layer is made of expandable foaming material which is thin when untreated, and when said cushion layer is heat-treated and vulcanized, said cushion layer is expanded to form a foaming cushion layer of said ball cushion.

17. A method of manufacturing a sports ball, which comprises the steps of:
(a) providing an inflatable bladder;
(b) forming an exterior web layer on said inflatable bladder;
(c) forming a ball cushion on said inflatable bladder in such a manner that said exterior web layer is sandwiched between said inflatable bladder and said ball cushion;
(d) forming a plurality of panel guidelines on an outer surface of said ball cushion to define a predetermined number of guiding contours between at least two adjacent panel guidelines; and
(e) affixing a plurality of carcass panels on said ball cushion to form a roundness ball carcass of said sports ball in a stitch-less manner, wherein each of said carcass panels has a peripheral edge and a flat bottom surface defined within said peripheral edge, wherein said bottom surface of each of said carcass panels is entirely affixed to said ball cushion at a position that said peripheral edge of each of said carcass panels is fittingly aligned with said corresponding panel guideline on a corresponding guideline contour to form said roundness ball carcass of said sports ball.

18. The method, as recited in claim 17, wherein said step (b) comprises the steps of winding at least one elongated strengthened thread evenly around said outer surface of said inflatable bladder to form said web layer embracing said inflatable bladder, and heat treating said exterior web layer attached on an outer surface of said inflatable bladder so as to form an integral exterior web layer on said inflatable bladder.

19. The method, as recited in claim 17, wherein said step (c) comprises the steps of:
(c.1) overlapping at least a cushion layer on said exterior web layer; and
(c.2) heat-treating said cushion layer to form an integral spherical foaming cushion around said exterior web layer to provide a cushion effect for said sports ball at any point thereof.

20. The method, as recited in claim 18, wherein said step (c) comprises the steps of:
(c.1) overlapping at least a cushion layer on said exterior web layer; and
(c.2) heat-treating said cushion layer to form an integral spherical foaming cushion around said exterior web layer to provide a cushion effect for said sports ball at any point thereof.
